(19) United States
(12) Patent Application Publication
(10) Pub. No.: US 2013/0201366 A1
(43) Pub. Date: Aug. 8, 2013

(54) IMAGE PROCESSING APPARATUS, IMAGE PROCESSING METHOD, AND PROGRAM

(71) Applicant: Sony Corporation, Tokyo (JP)

(72) Inventor: Koji OZAKI, Kanagawa (JP)

(73) Assignee: Sony Corporation, Tokyo (JP)

(21) Appl. No.: 13/708,128

(22) Filed: Dec. 7, 2012

(30) Foreign Application Priority Data
Feb. 3, 2012 (JP) 2012-021894

(51) Int. Cl. H04N 5/272

(52) U.S. Cl. CPC H04N 5/272
USPC 348/231.99; 348/239

(57) ABSTRACT

There is provided an image processing apparatus including an extraction unit for extracting a first still portion in an image based on a plurality of still images, and for extracting at least a part of a second still portion corresponding to a portion that is not extracted as the first still portion in an image based on the plurality of still images and a combining unit for combining the first still portion and the second still portion to generate a combined image.

### BACKGROUND

The present disclosure relates to an image processing apparatus, an image processing method, and a program.

For example, an image such as a picture captured in a tourist destination may often contain subjects other than a particular subject. Such an image may probably not be what the user (for example, an image-capturing person or a particular subject) intended.

Meanwhile, techniques for providing an image obtained by removing a moving subject in a background are being developed. An example of such techniques includes a technique disclosed in Japanese Patent Application Laid-Open Publication No. 2006-186637.

### SUMMARY

For example, Japanese Patent Application Laid-Open Publication No. 2006-186637 discloses a technique for combining a background image of a particular subject that is generated based on a plurality of images and a subject region image that corresponds to a particular subject region image extracted from a subject image including the particular subject. Thus, with the use of the technique disclosed in Japanese Patent Application Laid-Open Publication No. 2006-186637, there is a possibility to obtain an image from which a moving subject is removed in a background.

However, for example, the image from which a moving object is removed may not be necessarily obtained, because the technique disclosed in Japanese Patent Application Laid-Open Publication No. 2006-186637 uses a simple arithmetic mean to obtain the image from which a moving subject is removed in a background. More specifically, in a case using the technique disclosed in Japanese Patent Application Laid-Open Publication No. 2006-186637, when there is an object that rarely moves, or there is no particular subject region that contains an entire particular subject due to a moving object, it is very difficult to obtain the image from which a moving object is removed.

In accordance with an embodiment of the present disclosure, there is provided a novel and improved image processing apparatus, image processing method, and program, capable of obtaining an image from which a moving object is removed, based on a plurality of still images.

According to an embodiment of the present disclosure, there is provided an image processing apparatus which includes an extraction unit for extracting a first still portion in an image based on a plurality of still images and for extracting at least a part of a second still portion corresponding to a portion that is not extracted as the first still portion in an image based on the plurality of still images; and a combining unit for combining the first still portion and the second still portion to generate a combined image.

According to another embodiment of the present disclosure, there is provided an image processing method which includes extracting a first still portion in an image based on a plurality of still images; extracting at least a part of a second still portion corresponding to a portion that is not extracted as the first still portion in an image based on the plurality of still images; and combining the first still portion and the second still portion to generate a combined image.

According to another embodiment of the present disclosure, there is provided a program for causing a computer to execute a process which includes extracting a first still portion in an image based on a plurality of still images; extracting at least a part of a second still portion corresponding to a portion that is not extracted as the first still portion in an image based on the plurality of still images; and combining the first still portion and the second still portion to generate a combined image.

According to embodiments of the present disclosure, it is possible to obtain an image from which a moving object is removed, based on a plurality of still images.

### BRIEF DESCRIPTION OF THE DRAWINGS

FIG. 1 is an explanatory diagram illustrating an image processing method according to an embodiment of the present disclosure;

FIG. 2 is an explanatory diagram illustrating an example of an image processing according to the related art;

FIG. 3 is an explanatory diagram illustrating a first example of a problem that may occur in the image processing according to the related art;

FIG. 4 is an explanatory diagram illustrating a second example of a problem that may occur in the image processing according to the related art;

FIG. 5 is an explanatory diagram illustrating an overview of a process according to an image processing method of the present embodiment;

FIG. 6 is an explanatory diagram illustrating an example of a notification control of an image processing apparatus according to the present embodiment;

FIG. 7 is an explanatory diagram illustrating an example of the process according to the image processing method of the present embodiment;

FIG. 8 is an explanatory diagram illustrating an example of the process according to the image processing method of the present embodiment;

FIG. 9 is an explanatory diagram illustrating an exemplary display control process according to the present embodiment;

FIG. 10 is an explanatory diagram illustrating another exemplary display control process according to the present embodiment;

FIG. 11 is an explanatory diagram illustrating yet another exemplary display control process according to the present embodiment;

FIG. 12 is an explanatory diagram illustrating an example of the process according to the image processing method of the present embodiment;

FIG. 13 is an explanatory diagram illustrating an example of the process according to the image processing method of the present embodiment;

FIG. 14 is an explanatory diagram illustrating an example of the process according to the image processing method of the present embodiment;

FIG. 15 is an explanatory diagram illustrating an example of the process according to the image processing method of the present embodiment;

FIG. 16 is an explanatory diagram illustrating an example of the process according to the image processing method of the present embodiment;

FIG. 17 is an explanatory diagram illustrating an example of the process according to the image processing method of the present embodiment;

FIG. 18 is an explanatory diagram illustrating an example of the process according to the image processing method of the present embodiment;

FIG. 19 is an explanatory diagram illustrating an example of the process according to the image processing method of the present embodiment;

FIG. 20 is an explanatory diagram illustrating an example of the process according to the image processing method of the present embodiment;

FIG. 21 is an explanatory diagram illustrating an example of the process according to the image processing method of the present embodiment;

FIG. 22 is an explanatory diagram illustrating an example of the process according to the image processing method of the present embodiment;

FIG. 23 is a flowchart illustrating an example of the process according to the image processing method of the present embodiment;

FIG. 24 is a flowchart illustrating an example of a progress display process according to the image processing method of the present embodiment;

FIG. 25 is a flowchart illustrating another example of the progress display process according to the image processing method of the present embodiment;

FIG. 26 is a block diagram illustrating an exemplary configuration of an image processing apparatus according to an embodiment of the present disclosure; and

FIG. 27 is an explanatory diagram illustrating an exemplary hardware configuration of the image processing apparatus according to the present embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

1. Image Processing Method according to an Embodiment of the Present Disclosure

2. Image Processing Apparatus according to an Embodiment of the Present Disclosure

3. Program according to an Embodiment of the Present Disclosure

### Image Processing Method according to an Embodiment of the Present Disclosure

An image processing method according to an embodiment of the present disclosure will be described first, and then a configuration of an image processing apparatus according to an embodiment of the present disclosure will be described. The following explanation is on the assumption that the image processing apparatus according to the present embodiment performs a process according to the image processing method of the present embodiment.

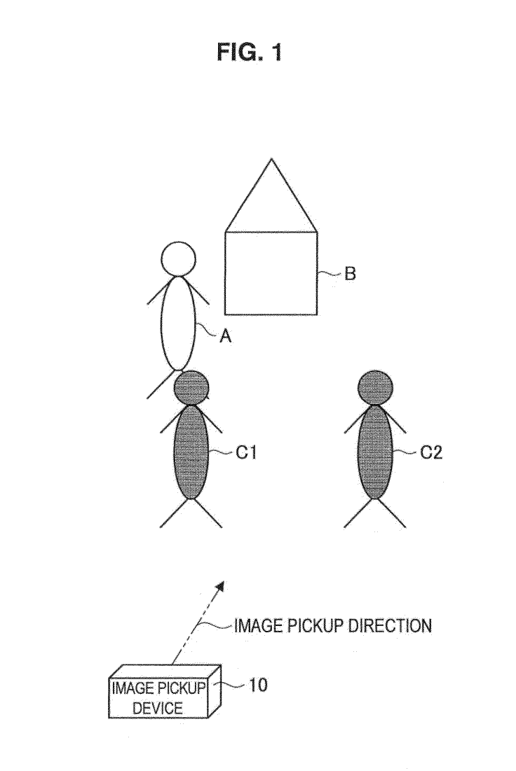

FIG. 1 is an explanatory diagram illustrating the image processing method according to the present embodiment. FIG. 1 illustrates an exemplary case where a subject denoted by A in the figure (a subject to be captured) is captured by an image pickup device 10. In the example of FIG. 1, there is an assumption that an image is obtained by capturing. This image contains a house denoted by B in FIG. 1 (an example of a still object) and subjects denoted each by C1 and C2 in FIG. 1 (subjects other than the subject to be captured; an example of a moving object), in addition to the subject denoted by A in FIG. 1.

A process according to the image processing method of the present embodiment will be described below, by taking as an example the image obtained by capturing, in the case as shown in FIG. 1. In addition, an image to be processed by the process according to the image processing method of the present embodiment is not limited to the image captured by the image pickup device as shown in FIG. 1. For example, the image to be processed by the process according to the image processing method of the present embodiment may be an image stored in a recording medium. Additionally, an example of the image stored in a recording medium according to the present embodiment include, for example, an image (a combined image to be described later) generated by the process according to the image processing method of the present embodiment.

In this example, the recording medium according to the present embodiment stores an image. An example of the recording medium includes a storage unit (to be described later) or RAM (Random Access Memory; not shown) provided in the image processing apparatus according to the present embodiment, a removable external recording medium detachably connected to the image processing apparatus according to the present embodiment, and a recording medium provided in an external device. This external device is connected to the image processing apparatus according to the present embodiment via a network (or directly, not through a network) on a wired or wireless connection. When an image stored in a recording medium provided in an external device is processed, the image processing apparatus according to the present embodiment obtains the image from the external device by transmitting an image transmission request to the external device. The image transmission request is a signal for causing the external device to transmit an image.

Further, an image to be processed by the process according to the image processing method of the present embodiment may include both a captured image and an image stored in a recording medium. In other words, an example of an image to be processed by the process according to the image processing method of the present embodiment may include, for example, either of a captured image or an image stored in a recording medium or both of them.

Moreover, an image to be processed in the process according to the image processing method of the present embodiment by the image processing apparatus according to the present embodiment may be a still image. In this case, a still image according to the present embodiment may be a frame image constituting a moving image as well as a still image. A frame image according to the present embodiment may be, for example, an image corresponding to a single frame of a moving image (which corresponds to a single field of a moving image, if the moving image is an interlaced image). The following explanation will be made with respect to a case where an image to be processed in the process according to the image processing method of the present embodiment is a still image according to the present embodiment. In addition, the still image may be simply referred to as “image” hereinafter.

[1] Problems of the Related Art

Prior to the explanation of the image processing method according to the present embodiment, an example of problems of the related art such as a technique disclosed in, for example, Japanese Patent Application Laid-Open Publication No. 2006-186637 will now be described.

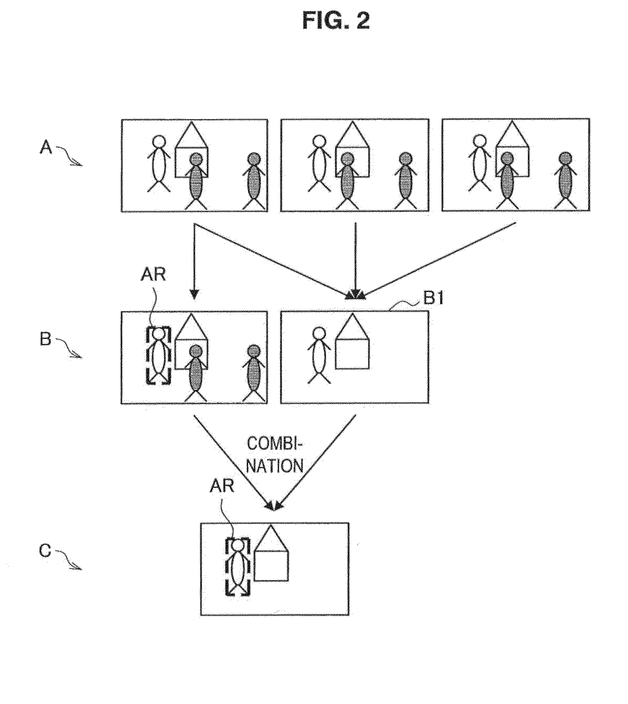

FIG. 2 is an explanatory diagram illustrating an example of an image processing according to the related art. An image to be processed (hereinafter, may be referred to as “original image”) is denoted by A in FIG. 2. In addition, B in FIG. 2 indicates an example of an image obtained at an intermediate stage of the process, and C in FIG. 2 indicates an example of a combined image (hereinafter, may be referred to as “final image”) obtained as a final result of the process.

An image processing apparatus which employs the related art (hereinafter, may be referred to as “image processing apparatus of related art”) specifies a region which contains a particular subject in an original image from a subject image which contains the particular subject in the original image (AR shown in B of FIG. 2). In addition, the image processing apparatus of related art generates a background image based on a plurality of original images (B1 shown in B of FIG. 2). The image processing apparatus of related art then combines the background image and a subject region image that corresponds to a particular subject region extracted from the subject image (C shown in FIG. 2).

For example, as shown in FIG. 2, in a case where a particular subject is not hidden by any other subjects and the number of moving objects is small, even if the related art is employed, there may be a possibility to acquire an image obtained by removing a moving subject from the background. However, as described above, the related art such as a technique disclosed in, for example, Japanese Patent Application Laid-Open Publication No. 2006-186637, uses a simple arithmetic mean to obtain the image from which a moving subject is removed in the background, and thus the image from which a moving object is removed may not be necessarily obtained. An example of problems that would arise at the time of using the related art will be described.

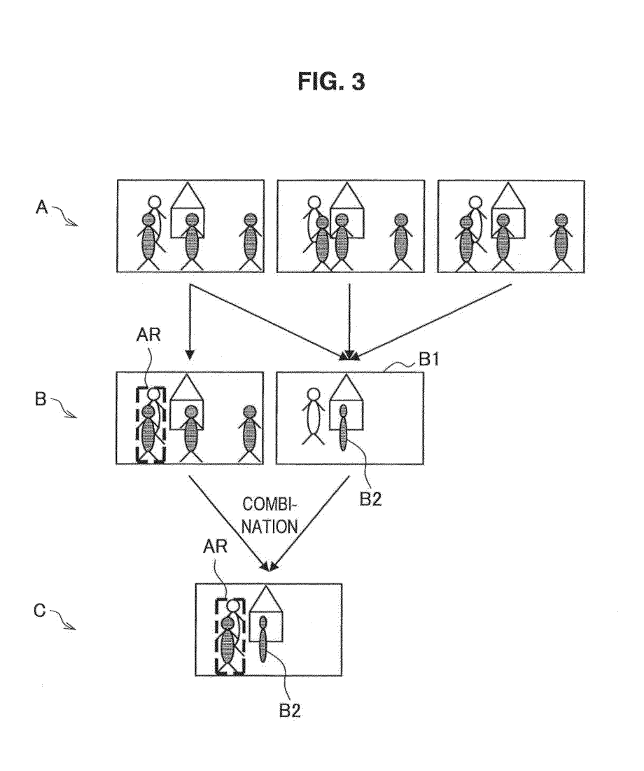

FIG. 3 is an explanatory diagram illustrating a first example of a problem that may occur in the image processing according to the related art. An image to be processed (an original image) is denoted by A in FIG. 3. In addition, B shown in FIG. 3 indicates an example of an image obtained at an intermediate stage of the process, and C in FIG. 3 indicates an example of a combined image (a final image) obtained as a final result of the process. In this example, FIG. 3 illustrates an exemplary process according to the related art in a case where a particular subject is hidden by any other subjects or the number of moving objects is larger than that shown in FIG. 2.

The image processing apparatus of related art specifies a region that contains a particular subject from a subject image that contains the particular subject in an original image (AR shown in B of FIG. 3). In this example, in the original image shown in A of FIG. 3, the particular subject is hidden by another subject, and thus another subject will be contained in the region that contains the specified particular subject.

Further, the image processing apparatus of related art generates a background image (B1 shown in B of FIG. 3) based on a plurality of original images. In this case, the image processing apparatus of related art generates the background image by using a simple arithmetic mean. Thus, for example, if a time taken for the moving objects to be overlapped to each other is longer due to a large number of the moving objects contained in the original image, then the moving object (or a portion of the moving object; for example, B2 shown in B of FIG. 3) may remain in the background image generated by the image processing apparatus of related art (B 1 shown in B of FIG. 3). Therefore, the image processing apparatus of related art combines the background image and a subject region image that corresponds to a particular subject region extracted from a subject image (C shown in FIG. 3).

In this case, a moving object (or a portion of the moving object) remains in the background image, and another subject is contained in a subject region image. Thus, in a case where a particular subject is hidden by any other subjects and the number of moving objects is larger than that shown in FIG. 2, for example, as shown in FIG. 3, it may not necessarily be possible for the related art to obtain an image from which a moving object is removed.

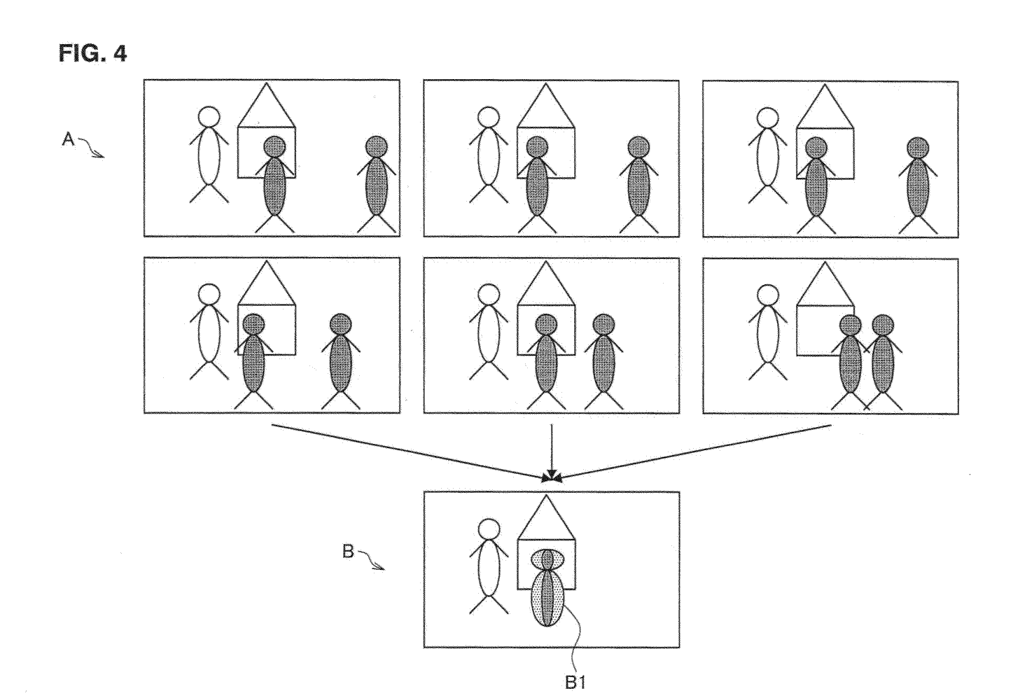

FIG. 4 is an explanatory diagram illustrating a second example of a problem that may occur in the image processing according to the related art. An image to be processed (an original image) is denoted by A in FIG. 4. In addition, B shown in FIG. 4 indicates an example of a combined image (a final image) obtained as a final result of the process. FIG. 4 illustrates an original image where a moving object is not moving so much such as moving only within a particular range.

The image processing apparatus of related art generates a background image using a simple arithmetic mean, and combines the generated background image and a subject region image. In this case, a moving object (or a portion of the moving object; for example, B1 shown in B of FIG. 4) may remain in the combined image. In addition, as the related art, when the background image is generated by using a simple arithmetic mean, the combined image may be appeared as an unnatural image because a moving object is seen through.

[2] Overview of Image Processing Method according to the Embodiment

For example, as shown in FIGS. 3 and 4, even when the related art such as a technique disclosed in Japanese Patent Application Laid-Open Publication No. 2006-186637 is used, it may not necessarily be possible to obtain an image from which a moving object is removed based on a plurality of still images.

On the contrary, the image processing apparatus according to the present embodiment can obtain an image from which a moving object is removed based on a plurality of still images, for example, by performing the following items: (1) a first still portion extraction process, (2) a second still portion extraction process, and (3) a combined image generation process.

(1) First Still Portion Extraction Process

The image processing apparatus according to the present embodiment extracts a portion in which a moving object is not contained in an image (hereinafter, referred to as “first still portion”) based on a plurality of still images. More specifically, for example, the image processing apparatus according to the present embodiment calculates a motion vector based on a plurality of still images and extracts a first still portion based on the calculated motion vector.

In this example, the image processing apparatus according to the present embodiment may extract a still portion that contains a subject to be extracted as the first still portion. When a particular person is considered as a subject to be extracted, the image processing apparatus according to the present embodiment specifies the subject to be extracted, for example, by using face recognition technology. This face recognition technology detects feature points such as eye, nose, mouth, and facial skeleton, or detects a region similar to the brightness distribution and structural pattern of a face. In addition, when a particular object is considered as a subject to be extracted, the image processing apparatus according to the present embodiment specifies the subject to be extracted by using any object recognition technology. Additionally, the subject to be extracted may be specified based on an operation for allowing a user to specify a subject (an example of user operations). The image processing apparatus according to the present embodiment may perform a first still portion extraction process, while the number of still images to be processed is increased until a first still portion that contains the entire specified subject to be extracted is extracted. In this case, the image processing apparatus according to the present embodiment may determine whether the entire subject to be extracted is contained in the first still portion, by detecting the contour of a subject to be extracted using an edge detection method. In addition, in the image processing apparatus according to the present embodiment, the determination of whether the entire subject to be extracted is contained in the first still portion is not limited to the above example.

Further, in a case where a still portion that contains a subject to be extracted is extracted as the first still portion, the first still portion extraction process according to the present embodiment is not limited to the above example. For example, the image processing apparatus according to the present embodiment may extract a region that contains a portion of the specified subject to be extracted as the first still portion. Even when the region that contains a portion of the specified subject to be extracted is extracted as the first still portion, a process according to the image processing method of the present embodiment, as described later, allows an image from which a moving object is removed to be obtained.

(2) Second Still Portion Extraction Process

The image processing apparatus according to the present embodiment extracts a portion (hereinafter, referred to as “second still portion”) not extracted as the first still portion in an image, based on a plurality of still images. More specifically, the image processing apparatus according to the present embodiment, for example, calculates a motion vector based on a plurality of still images and extracts a second still portion based on the calculated motion vector. In this case, the plurality of still images to be processed that is used in a second still portion extraction process may or may not include a portion or all of the plurality of still images to be processed that is used in the first still portion extraction process.

In this example, the image processing apparatus according to the present embodiment may extract a new second still portion, for example, each time the number of still images to be processed increases. In addition, the second still portion extraction process performed in the image processing apparatus according to the present embodiment is not limited to the above example. For example, when the number of still images to be processed is predetermined, the image processing apparatus according to the present embodiment extracts the second still portion by processing the still image to be processed in a sequential manner.

(3) Combined Image Generation Process

The image processing apparatus according to the present embodiment combines the first still portion and the second still portion to generate a combined image.

In this example, when the first still portion is extracted and the second still portion is not yet extracted, the image processing apparatus according to the present embodiment regards only an image representing the extracted first still portion as a combined image. Then, when the second still portion is extracted, the image processing apparatus according to the present embodiment combines the first still portion and the second still portion to generate a combined image.

Furthermore, the image processing apparatus according to the present embodiment may generate a new combined image each time a new second still portion is extracted in the second still portion extraction process. More specifically, the image processing apparatus according to the present embodiment, each time a new second still portion is extracted, may combine the first still portion or the previously generated combined image with the newly extracted second still portion to generate a new combined image.

Moreover, for example, the image processing apparatus according to the present embodiment may cause the generated combined image to be recorded on a recording medium or may transmit the generated combined image to an external device.

In this example, the image processing apparatus according to the present embodiment causes a final combined image generated in the process (combined image generation process) of the above item (3) to be recorded on a recording medium and/or to be transmitted to an external device. However, the process in the image processing apparatus according to the present embodiment is not limited to the above example. For example, even before the final combined image is obtained, i.e. at an intermediate stage of the process (combined image generation process) of the above item (3), the image processing apparatus according to the present embodiment may cause the generated combined image to be recorded on a recording medium or to be transmitted to an external device.

As the example described above, at an intermediate stage of the process (combined image generation process) of the above item (3), a combined image obtained at an intermediate stage of the process (combined image generation process) of the above item (3) is recorded on a recording medium or is stored on an external device, by recording the combined image on a recoding medium and/or by transmitting the combined image to an external device. Thus, it is possible to avoid a situation where no combined image is obtained, for example, even when there is an accident caused by some reasons (e.g., power is shut off, or image pickup device is moved) at an intermediate stage of the process (combined image generation process) of the above item (3).

In this example, an example of the timing at which a combined image is recorded or transmitted at an intermediate stage of the process (combined image generation process) of the above item (3) includes a timing that is set according to an expected time taken to obtain a final combined image or a timing that is set according to a progress of the process (or percentage of completion of a combined image). An example of the timing that is set according to an expected time taken to obtain a final combined image may include a timing at which the recording or transmission is performed at intervals of one second, when it is expected to take three seconds until the final combined image is obtained. In addition, an example of the timing that is set according to the process progress (or percentage of completion of a combined image) may include a timing when the recording or transmission is performed each time the progress of the process (or percentage of completion of a combined image) reaches a predetermined percentage.

For example, the image processing apparatus according to the present embodiment performs the process (first still portion extraction process) of the above item (1), the process (second still portion extraction process) of the above item (2), and the process (combined image generation process) of the above item (3), as a process according to the image processing method of the present embodiment.

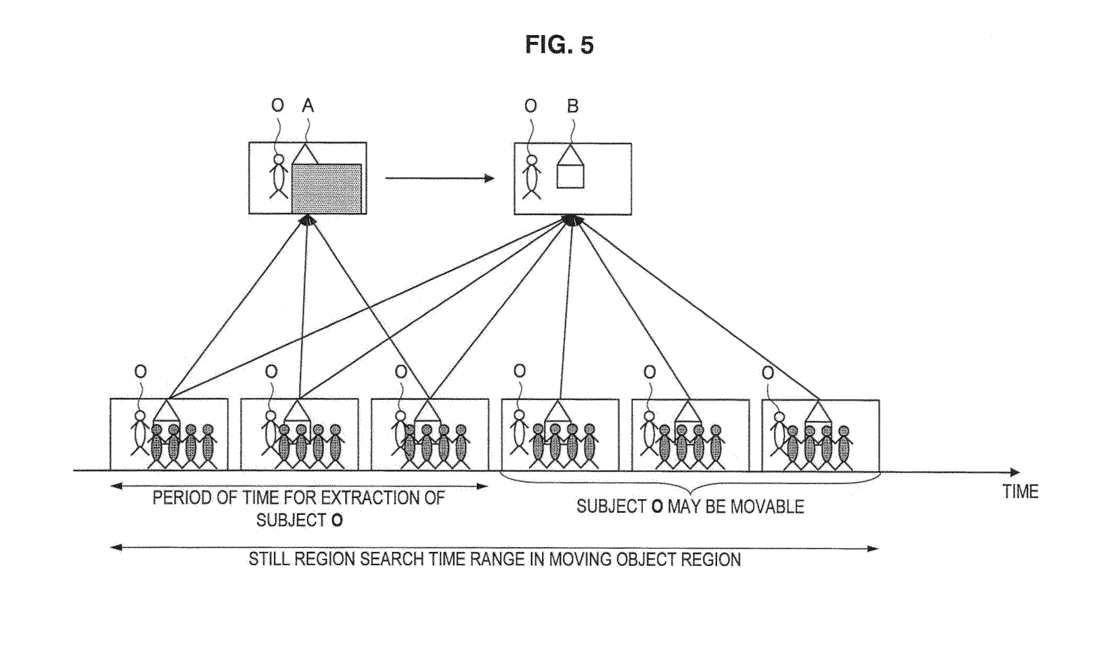

FIG. 5 is an explanatory diagram illustrating an overview of the process according to the image processing method of the present embodiment. In this example, FIG. 5 illustrates an example that the image processing apparatus according to the present embodiment performs the process according to the image processing method of the present embodiment, based on the image that is captured when a subject O of a particular person is an object to be captured. In addition, an example of an image that corresponds to a first still portion obtained by the first still portion extraction process is denoted by A in FIG. 5. An example of a combined image obtained by the second still portion extraction process and the combined image generation process is denoted by B in FIG. 5.

As shown in FIG. 5, a first still portion (A shown in FIG. 5) is extracted in the process (first still portion extraction process) of the above item (1). In addition, a second still portion extracted in the process (second still portion extraction process) of the above item (2) is combined in the process (combined image generation process) of the above item (3), and thus a combined image (B shown in FIG. 5) from which a moving object is removed can be obtained.

In this example, as shown in A of FIG. 5, FIG. 5 illustrates an example that the image processing apparatus according to the present embodiment extracts a still portion that contains the entire subject to be extracted in the process (first still portion extraction process) of the above item (1), as the first still portion. In this case, for example, when a still portion that contains the entire subject to be extracted is extracted as the first still portion, it is necessary for the subject O to be stationary at least until the first still portion is extracted (until the process (first still portion extraction process) of the above item (1) is completed).

However, when a still portion that contains the entire subject to be extracted is extracted as the first still portion, at the point of time when the first still portion is extracted, the entire subject O to be extracted will be contained in the extracted first still portion. In other words, even when the subject O is moved after the completion of the process (first still portion extraction process) of the above item (1), the subject O is previously contained in the first still portion. Thus, a combined image generated in the process (combined image generation process) of the above item (3) will contain the entire subject O.

Therefore, for example, when a captured image obtained by capturing a subject to be captured (A shown in FIG. 1) as shown in FIG. 1 is processed by the image processing apparatus according to the present embodiment, the subject to be captured is not necessary to be kept stationary until the entire process according to the image processing method of the present embodiment is completed. More specifically, the subject to be captured may be kept stationary only until the process (first still portion extraction process) of the above item (1) is completed. In this example, a region occupied by the subject to be captured in the entire image is often relatively small. Thus, a time necessary to complete the process (first still portion extraction process) of the above item (1) will be significantly shorter than a time necessary to complete a process for the entire image, that is, a time necessary to complete the process (first still portion extraction process) of the above item (1) to the process (combined image generation process) of the above item (3).

Therefore, the fact that image processing apparatus according to the present embodiment performs the process according to the image processing method of the present embodiment makes it possible to shorten the time necessary, for the subject to be captured, to be kept stationary and to reduce a load on the subject to be captured.

Further, as described above, the process in the image processing apparatus according to the present embodiment has been described by taking an example where a subject to be captured is extracted, another portion is extracted, and then they are combined. However, the process in the image processing apparatus according to the present embodiment is not limited to the above example. For example, after the entire image is extracted and combined previously, the image processing apparatus according to the present embodiment can also extract the subject to be captured by using a process or the like performed in the object recognition technology. This extraction of the subject to be captured is performed based on a captured image obtained by capturing the subject to be captured that has been moved to a position corresponding to a desired position in the entire image. Even in the above case, the image processing apparatus according to the present embodiment can generate an image that contains the subject to be captured. This is performed, for example, by combining the combined image obtained from the previously obtained extraction result and a portion of the subject to be captured which is extracted based on a captured image obtained by capturing the subject to be captured.

Furthermore, when the extraction of the first still portion is completed (when the process (first still portion extraction process) of the above item (1) is completed), the image processing apparatus according to the present embodiment may notify the user that the extraction of the first still portion is completed. In this case, an example of the user receiving the notification that the extraction of the first still portion is completed may include a holder of the image processing apparatus according to the present embodiment, a person of the subject to be captured, and an image-capturing person who captures a subject to be captured using an image pickup device.

The image processing apparatus according to the present embodiment can notify the subject to be captured whether the subject to be captured is allowed to move or not to, in a direct or indirect way. This is achieved by causing the image processing apparatus according to the present embodiment to notify a user that the extraction of the first still portion is completed. Thus, it is possible to improve the convenience of the user by allowing the image processing apparatus according to the present embodiment to notify the user that the extraction of the first still portion is completed.

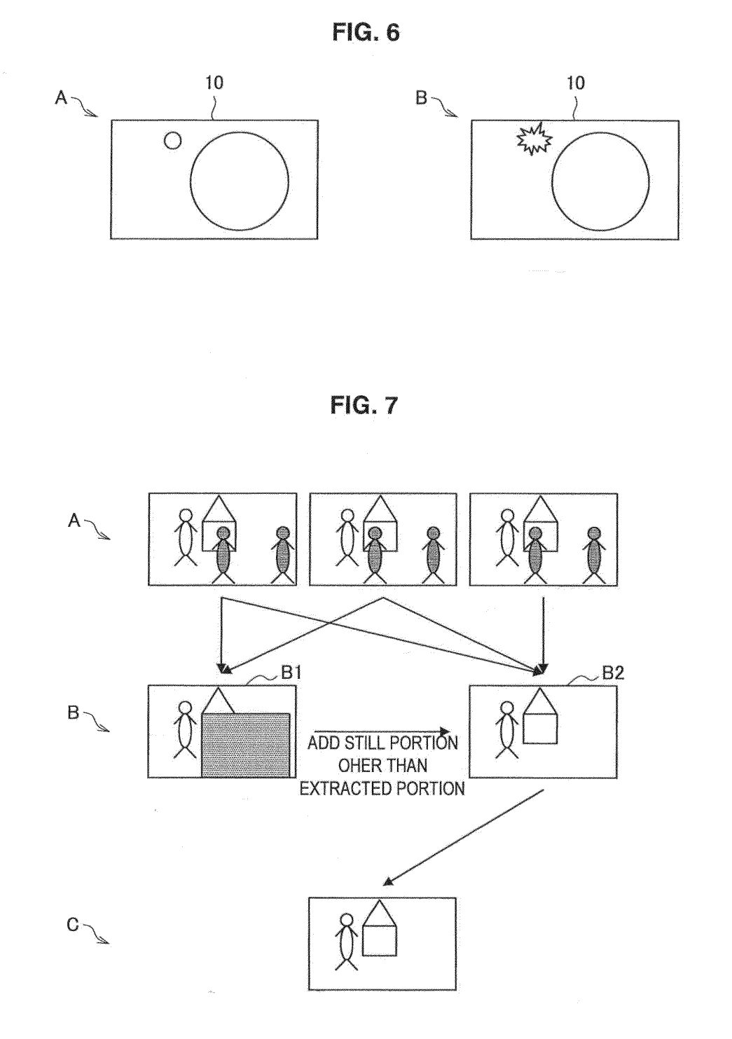

FIG. 6 is an explanatory diagram illustrating an exemplary notification control in the image processing apparatus according to the present embodiment. In this example, FIG. 6 illustrates an example that the image processing apparatus according to the present embodiment controls an image pickup device 10 shown in FIG. 1 to notify a particular subject (an example of the user) that the extraction of the first still portion is completed. A state before the image pickup device 10 performs the notification is denoted by A in FIG. 6, and B shown in FIG. 6 indicates an example of the state where image pickup device 10 is performing the notification by the control of the image processing apparatus according to the present embodiment.

When the process (first still portion extraction process) of the above item (1) is completed, the image processing apparatus according to the present embodiment transmits a notification command to the image pickup device 10. The image pickup device 10 is connected to the image processing apparatus via a network (or directly) on a wired or wireless connection. When the image pickup device 10 receives the notification command from the image processing apparatus according to the present embodiment, the image pickup device 10 performs a visual notification by turning on a lamp based on the received notification command (B shown in FIG. 6). In this case, the notification according to the present embodiment, such as the visual notification shown in FIG. 6 may be continued until the process (first still portion extraction process) of the above item (1) is completed, or may be stopped after a predetermined time has elapsed from the start of the notification.

Further, the notification control in the image processing apparatus according to the present embodiment is not limited to the visual notification shown in FIG. 6. For example, the image processing apparatus according to the present embodiment may cause another device to perform an audible notification by transmitting a notification command that is used to acoustically perform a notification with a voice (including music) to another device that will perform a notification. In this case, the notification command used to perform an audible notification may further include an audio data in addition to data (a command itself) representing a process to be performed.

Furthermore, in the above example, there has been described an example in which the image processing apparatus according to the present embodiment transmits a notification command to another device that performs a notification, and thus cause the device to notify a user that the extraction of the first still portion is completed. However, the notification control of the image processing apparatus according to the present embodiment is not limited to the above example. For example, when the image processing apparatus according to the present embodiment performs a notification, such as when the image processing apparatus according to the present embodiment is the image pickup device 10 shown in FIG. 6, the image processing apparatus according to the present embodiment may perform a notification to a user by controlling itself as the notification control.

In this example, in order to make a comparison with the related art such as a technique, for example, disclosed in Japanese Patent Application Laid-Open Publication No. 2006-186637, an example of results obtained by the process according to the image processing method of the present embodiment will be described in examples used to explain problems that may occur in the above-mentioned related art.

FIG. 7 is an explanatory diagram illustrating an example of the process according to the image processing method of the present embodiment. An image to be processed (original image) is denoted by A in FIG. 7. In addition, B shown in FIG. 7 indicates an example of an image obtained at an intermediate stage of the process, and C shown in FIG. 7 indicates an example of a combined image (a final image) obtained as a final result of the process. In this example, FIG. 7 illustrates a case where an original image is similar to that of FIG. 2 showing an example of the image processing according to the related art, i.e. when a particular subject is not hidden by any other subjects and the number of moving objects is small.

The image processing apparatus according to the present embodiment extracts a first still portion based on a plurality of original images (B1 shown in FIG. 7), and combines a second still portion that is a portion other than the first still portion based on the plurality of original images (B2 shown in FIG. 7). Thus, as shown in A of FIG. 7, when a particular subject is not hidden by any other subjects and the number of moving objects is small, the image processing apparatus according to the present embodiment can obtain an image from which the moving object is removed (C shown in FIG. 7).

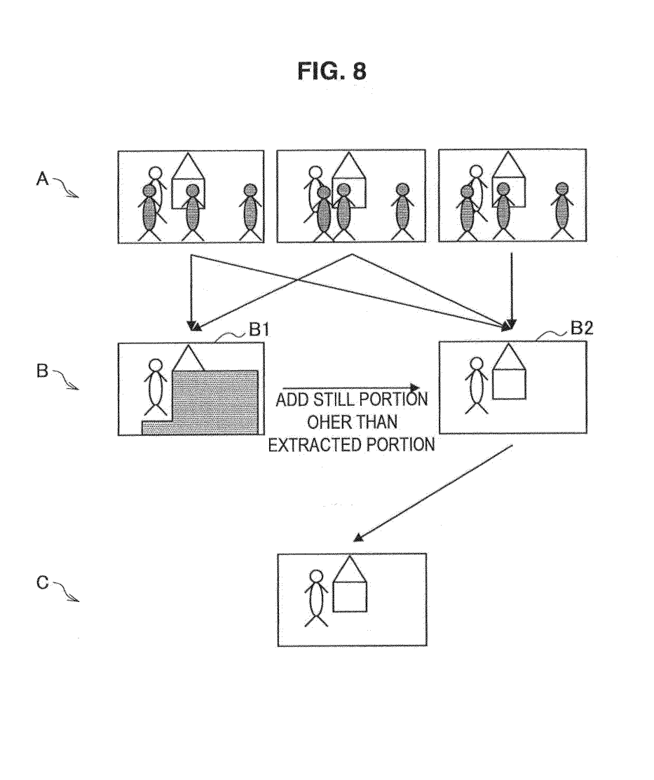

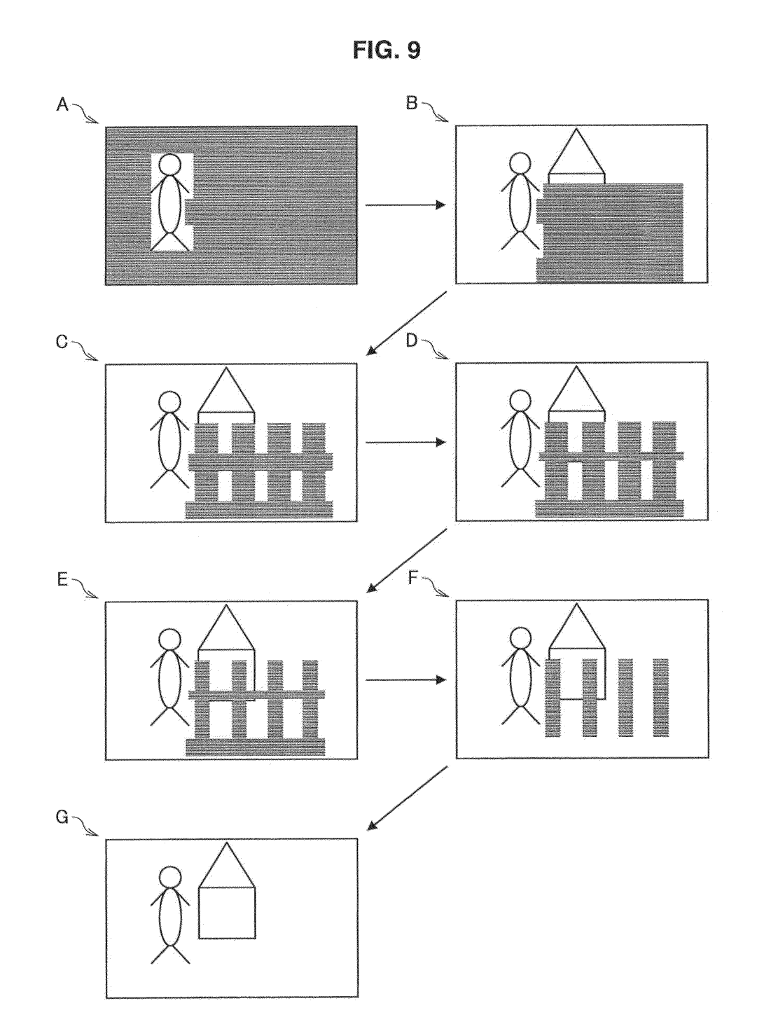

FIG. 8 is an explanatory diagram illustrating an example of the process according to the image processing method of the present embodiment. An image to be processed (original image) is denoted by A in FIG. 8. In addition, B shown in FIG. 8 indicates an example of an image obtained at an intermediate stage of the process, and C shown in FIG. 8 indicates an example of a combined image (a final image) obtained as a final result of the process. In this example, FIG. 8 illustrates a case where an original image is similar to that of FIG. 3 that shows an example of the image processing according to the related art, i.e. when a particular subject is hidden by any other subjects and the number of moving objects is larger than the example shown in FIG. 7.

The image processing apparatus according to the present embodiment extracts a first still portion based on a plurality of original images (B1 shown in FIG. 8), extracts a second still portion that is a portion other than the first still portion based on the plurality of original images, and combines the first still portion and the second still portion (B2 shown in FIG. 8). In this example, unlike the related art in which a combined image is obtained by using a simple arithmetic mean, the image processing apparatus according to the present embodiment extracts a still portion on the basis of a motion vector calculated based on a plurality of still images, in each of the process (first still portion extraction process) of the above item (1) and the process (second still portion extraction process) of the above item (2).

Thus, as shown in A of FIG. 8, even when a particular subject is hidden by any other subjects and the number of moving objects is larger than that shown in FIG. 7, the image processing apparatus according to the present embodiment can obtain an image from which a moving object is removed (C shown in FIG. 8). In addition, although not shown in the figure, the image processing apparatus according to the present embodiment extracts a still portion based on the calculated motion vector without using a simple arithmetic mean as in the related art. Therefore, there will be no problem that may occur in the related art as shown in FIG. 4.

As shown in FIG. 7, when there is no problem that may occur when using the related art, the image processing apparatus according to the present embodiment performs the process according to the image processing method of the present embodiment, and thus can obtain an image from which a moving object is removed. In addition, as shown in FIG. 8, even when there is a problem that may occur when the related art is used, it is possible to obtain an image from which a moving object is removed, by performing the process according to the image processing method of the present embodiment by the image processing apparatus according to the present embodiment.

Therefore, the image processing apparatus according to the present embodiment can obtain an image from which the moving object is removed, based on a plurality of still images, for example, by performing the process (first still portion extraction process) of the above item (1) to the process (combined image generation process) of the above item (3) as the process according to the image processing method of the present embodiment.

Further, the process according to the image processing method of the present embodiment is not limited to the process (first still portion extraction process) of the above item (1) to the process (combined image generation process) of the above item (3). For example, the image processing apparatus according to the present embodiment may perform a process (capturing process) for capturing an image to be captured as the process according to the image processing method of the present embodiment. In the capturing process, the image processing apparatus according to the present embodiment, for example, cause an image pickup unit (to be described later) to perform the capturing, or controls an external image pickup device to capture an image. When the capturing process is performed, the image processing apparatus according to the present embodiment can regard a captured image obtained by the capturing process as an image to be processed, in the process (first still portion extraction process) of the above item (1) and/or the process (second still portion extraction process) of the above item (2).

Moreover, the image processing apparatus according to the present embodiment may cause a combined image generated in the process (combined image generation process) of the above item (3) to be displayed on a display screen (display control process), by using the image processing method according to the present embodiment. An example of the display screen on which a combined image according to the present embodiment is displayed may include a display screen of a display unit (to be described later), and a display screen of an external device connected via a network (or directly, not through a network) on a wired or wireless connection.

In this example, as an example of the display control process according to the present embodiment, there may be exemplified a process for causing a final combined image generated in the process (combined image generation process) of the above item (3) to be displayed on a display screen. However, the display control process according to the present embodiment is not limited to the above example. For example, the image processing apparatus according to the present embodiment may cause the progress of the process made during obtaining a final combined image of the process according to the image processing method of the present embodiment to be displayed on the display screen.

FIG. 9 is an explanatory diagram illustrating an example of the display control process according to the present embodiment. Specifically, FIG. 9 illustrates an example of the process progress that indicates the progress of the process performed by the image processing method according to the present embodiment. In this example, FIG. 9 shows an example of results obtained by the display control process. In FIG. 9, images are displayed sequentially when the progress made during obtaining a final combined image of the process according to the image processing method of the present embodiment is displayed on the display screen.

The image processing apparatus according to the present embodiment extracts a first still portion based on a plurality of still images, and causes an image (combined image) indicating the extracted first still portion to be displayed on a display screen (A shown in FIG. 9). In this example, the A shown in FIG. 9 indicates an example in which the image processing apparatus according to the present embodiment extracts a minimum region that contains a particular subject as the first still portion by performing a face recognition process and contour extraction process in the process (first still portion extraction process) of the above item (1). In addition, the first still portion obtained by performing the first still portion extraction process according to the present embodiment is not limited to the minimum region that contains the particular subject as shown in A of FIG. 9.

Further, for example, the image processing apparatus according to the present embodiment may apply a color to a portion not extracted as the first still portion in an image (an example of a portion that is not included in either of the first still portion or second still portion), and cause the colored combined image to be displayed on a display screen. In this example, the image processing apparatus according to the present embodiment may apply a monochromatic color such as gray, for example, as shown in A of FIG. 9, but a color applied to the portion not extracted as the first still portion by the image processing apparatus according to the present embodiment is not limited to the above example.

When the first still portion is extracted, the image processing apparatus according to the present embodiment extracts a second still portion based on a plurality of still images. The image processing apparatus according to the present embodiment, for example, each time a new second still portion is extracted, may combine the first still portion or the previous generated combined image and the newly extracted second still portion, and then generates a new combined image. Then, the image processing apparatus according to the present embodiment, each time a combined image is generated, causes the generated combined image to be displayed on a display screen (B to G of FIG. 9).

Furthermore, the image processing apparatus according to the present embodiment, for example, applies a color to a portion that is not included in either of the first still portion or second still portion in an image, and causes the colored combined image to be displayed on a display screen. In this example, although the image processing apparatus according to the present embodiment applies a monochromatic color such as gray, for example, as shown in B to G of FIG. 9, a color applied to the portion not extracted as the first still portion and second still portion is not limited to the above example.

For example, in the images displayed on the display screen by performing the process as the above example in the image processing apparatus according to the present embodiment, the area of a portion (a portion to which a gray color shown in A to F of FIG. 9 is applied) that is not included in either of the first still portion or second still portion is gradually reduced, as shown in B to G of FIG. 9. Therefore, for example, the image processing apparatus of the present embodiment displays the progress of the process as shown in FIG. 9, and thus a user can visually recognize the progress of the process according to the image processing method of the present embodiment. In addition, for example, the image processing apparatus of the present embodiment displays the progress of the process as shown in FIG. 9, and thus a user can expect the remaining time until a final combined image is obtained.

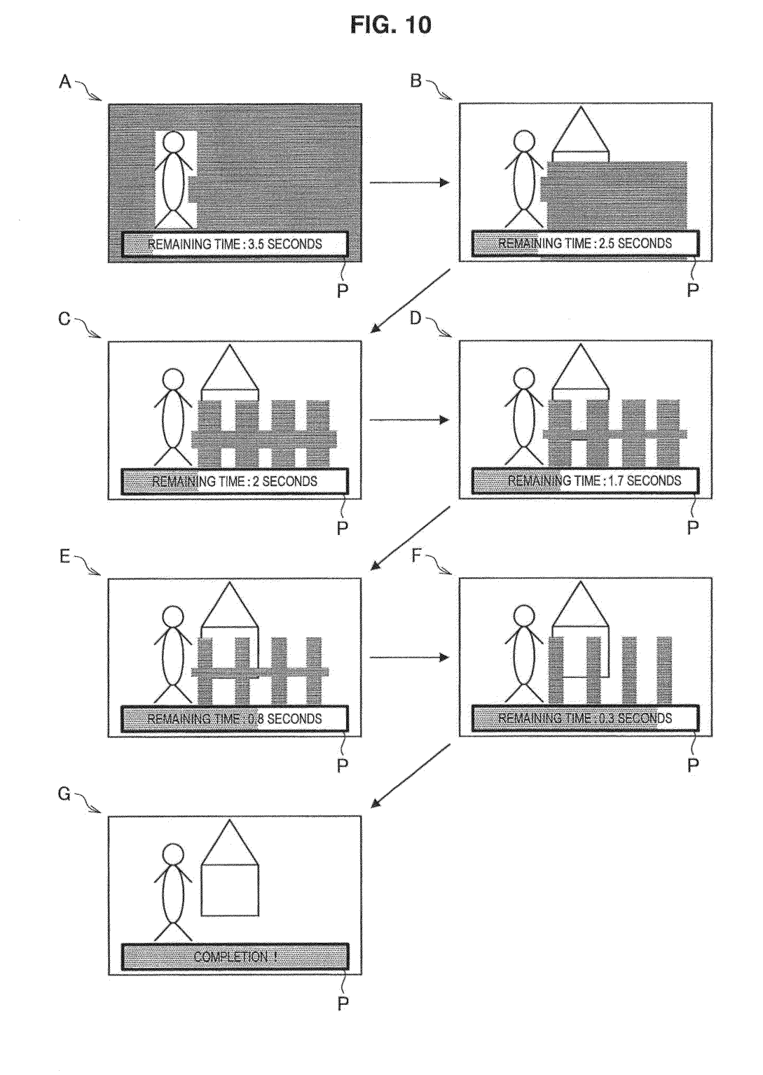

The progress display that indicates the progress of the process according to the image processing method of the present embodiment is not limited to the example in FIG. 9. FIG. 10 is an explanatory diagram illustrating another example of the display control process according to the present embodiment, and specifically illustrates an example of the progress display that indicates the progress of the process according to the image processing method of the present embodiment. In this example, an image shown in A of FIG. 10 corresponds to the image shown in A of FIG. 9, and similarly, images shown in B to G of FIG. 10 correspond to the respective images shown in B to G of FIG. 9.

For example, as shown in FIG. 10, the image processing apparatus of the present embodiment may allow a progress bar P that indicates the progress of the process (or, percentage of completion of combined image) to be displayed as an example of the progress display. The display of the progress bar P makes it possible to present the progress of the process to a user visually by the image processing apparatus according to the present embodiment. An example of method for visually presenting the progress of the process according to the present embodiment is not limited to the progress bar P shown in FIG. 10. For example, the image processing apparatus of the present embodiment may display a time necessary until a combined image is completed (or expected time), or alternatively, may display both the time necessary until a combined image is completed and the progress of the process (or percentage of completion of combined image) as shown in FIG. 10.

Furthermore, for example, the image processing apparatus according to the present embodiment may represent results obtained by the process according to the image processing method of the present embodiment by applying color to the results.

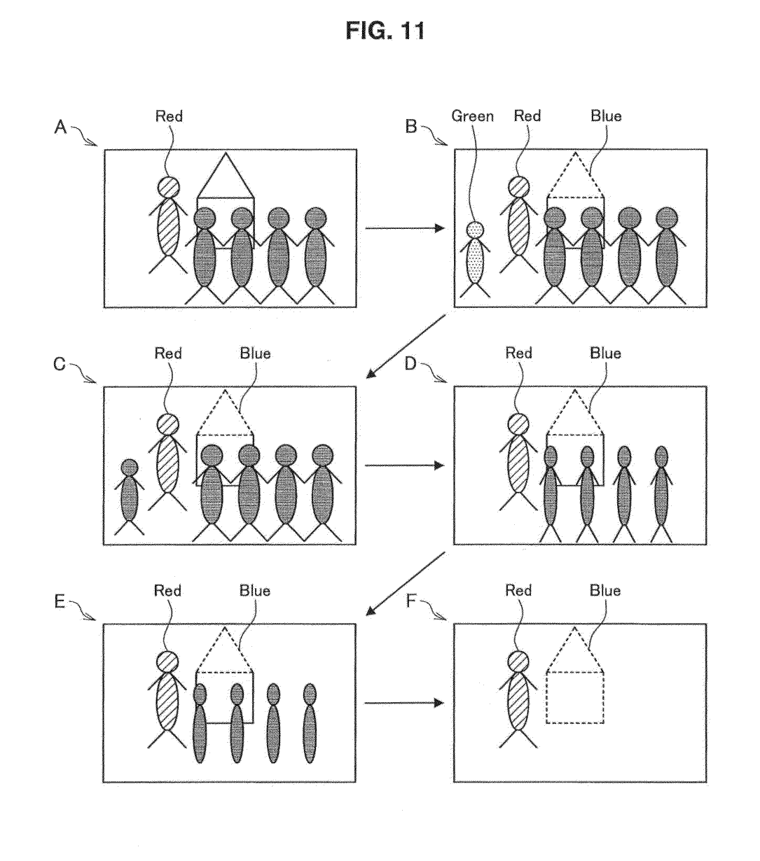

FIG. 11 is an explanatory diagram illustrating another example of the display control process according to the present embodiment, and specifically illustrates an example of the progress display that indicates the progress of the process according to the image processing method of the present embodiment. In this example, FIG. 11 illustrates an example of results obtained by the display control process. As similar to FIG. 9, when the progress of the progress made during obtaining a final combined image of the process according to the image processing method of the present embodiment is displayed on a display screen, FIG. 11 shows images displayed on the display screen sequentially. In addition, FIG. 11 shows an example in which color (represent as colors of “Red”, “Blue”, and “Green”, for convenience) is applied to a portion extracted as a still portion in an image.

The image processing apparatus according to the present embodiment applies the color “Red” to a first still portion extracted in the process (first still portion extraction process) of the above item (1) (A shown in FIG. 11). In addition, the image processing apparatus according to the present embodiment applies another color to a second still portion extracted in the process (second still portion extraction process) of the above item (2). For example, B shown in FIG. 11 shows an example in which the colors “Blue” and “Green” are applied to the extracted second still portions. In this case, for example, if a person of a subject to which the color “Green” is applied is moved during the process (second still portion extraction process) of the above item (2), then the color “Green” applied to the person of the subject is deleted (C shown in FIG. 11). Additionally, in a case where the number of still images to be processed by the process (second still portion extraction process) of the above item (2) increases and the area of the portion that is not included in either of the first still portion or second still portion becomes small, a portion to which color is not applied is gradually deleted (D to E shown in FIG. 11). Then, a final combined image is displayed on a display screen (F shown in FIG. 11).

For example, even when the progress of the process according to the image processing method of the present embodiment is represented by colors as shown in FIG. 11, a user can visually recognize the progress of the process according to the image processing method of the present embodiment, similar to the progress display shown in FIG. 9. In addition, for example, the image processing apparatus of the present embodiment performs the progress display as shown in FIG. 11, and thus a user can expect the remaining time until a final combined image is obtained, similar to the progress display shown in FIG. 9.

For example, the image processing apparatus of the present embodiment can implement the progress of the process as shown in FIG. 9 and FIG. 11, by further performing the display control process as the process according to the image processing method of the present embodiment.

In this example, the image processing apparatus according to the present embodiment causes results obtained by the process according to the image processing method of the present embodiment to be displayed on a display screen. In this case, the results are obtained by performing the process to the still image of each of the process (first still portion extraction process) of the above item (1) and the process (second still portion extraction process) of the above item (2). However, the display control process according to the present embodiment is not limited to the above example. For example, the image processing apparatus of the present embodiment may cause results obtained by the process according to the image processing method of the present embodiment to be displayed on a display screen. In this case, the results are obtained by performing the process to a reduced image in which a still image to be processed is reduced.

More specifically, for example, the image processing apparatus according to the present embodiment extracts a first still portion corresponding to a reduced image to which a still image to be processed is reduced, based on the reduced image, in the process (first still portion extraction process) of the above item (1). In addition, for example, each time the number of still images to be processed increases in the process (second still portion extraction process) of the above item (2), the image processing apparatus according to the present embodiment extracts a new second still image corresponding a reduced image to which the still image to be processed is reduced. The extraction of the new second still image is performed based on the reduced image. In addition, in the process (combined image generation process) of the above item (3), for example, the image processing apparatus of the present embodiment combines the first still portion corresponding to the reduced image or the previously generated combined image corresponding to the reduced image and a newly extracted second still portion corresponding to the reduced image. In this example, the image processing apparatus of the present embodiment, for example, performs the combination each time a second still portion corresponding to the reduced image is newly extracted in the process (combined image generation process) of the above item (3), thereby generating a new combined image corresponding to the reduced image. Then, the image processing apparatus of the present embodiment, for example, each time a combined image corresponding to the reduced image is generated in the above-mentioned display control process, allows the generated combined image to be displayed on a display screen.

Further, for example, as described above, when results obtained by the process according to the image processing method of the present embodiment performed with respect to the reduced image are displayed on a display screen, the image processing apparatus of the present embodiment, for example, performs a process to the still image to be processed, after a final combined image corresponding to the reduced image is obtained. In this example, the process for the progress display with respect to the reduced image has a significantly reduced load as compared with the process for the progress display to the still image to be processed. That is, the time necessary to perform the process of the progress display to the reduced image becomes shorter than the time necessary to perform the process of the progress display to the still image to be processed.

For example, as described above, the image processing apparatus of the present embodiment allows the results obtained by the process according to the image processing method of the present embodiment performed with respect to the reduced image to be displayed on a display screen, thereby reducing the time taken from the start to the completion of the progress display. Therefore, when the progress display that indicates a progress of the process according to the image processing method of the present embodiment is performed, the user latency can be reduced.

[3] Specific Example in Process according to Image Processing Method of the Present Embodiment

Next, the process according to the image processing method of the present embodiment will be described in more detail.

(i) Process for obtaining a Desired Combined Image

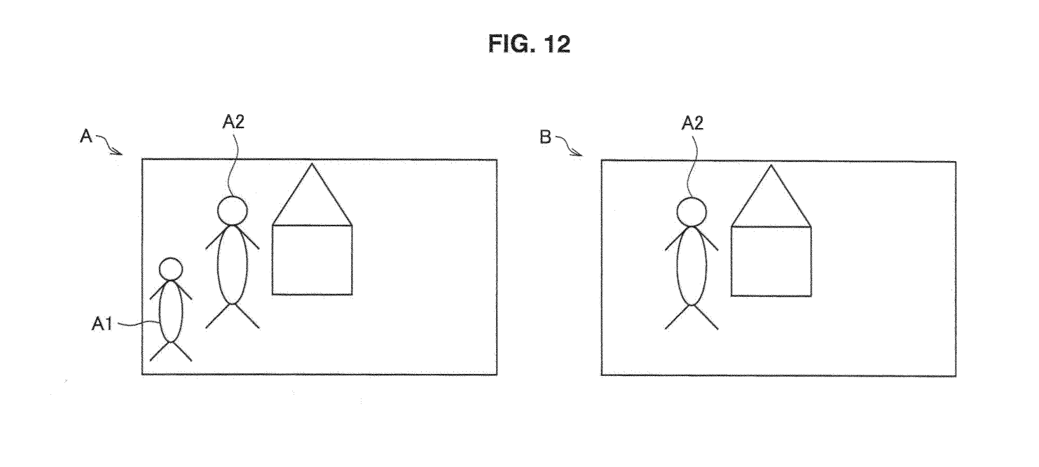

FIG. 12 is an explanatory diagram illustrating an example of the process according to the image processing method of the present embodiment. An example of a combined image obtained by performing the process (first still portion extraction process) of the above item (1) to the process (combined image generation process) of the above item (3) with respect to a plurality of still images in the image processing apparatus of the present embodiment is denoted by A in FIG. 12. In addition, an example of an image the user desires is denoted by B in FIG. 12.

As shown in A and B of FIG. 12, there may be a case where the user may not obtain a desired image, depending on a plurality of still images to be processed by the image processing apparatus according to the present embodiment. For example, in the example shown in FIG. 12, a subject A1 shown in A of FIG. 12 corresponds to a subject unnecessary to produce a combined image. In this example, the unnecessary subject A1 in A of FIG. 12 is contained in the combined image, this is because it is not determined that the subject A1 has moved in the plurality of still images.

Even when the unnecessary subject A1 as shown in A of FIG. 12 is contained, the image processing apparatus of the present embodiment can perform the process (second still portion extraction process) of the above item (2), based on the combined image shown in A of FIG. 12 and another still image. As a result, the desired combined image shown in B of FIG. 12 can be obtained. More specifically, for example, when any motion in the subject A1 is detected based on an image obtained by performing the capturing or an image stored in a storage medium and the combined image shown in A of FIG. 12, the desired combined image shown in B of FIG. 12 can be obtained. In addition, a subject A2 shown in FIG. 12 is extracted as the first still portion in the process (first still portion extraction process) of the above item (1). Thus, even if the capturing is further performed to obtain the desired combined image shown in FIG. 12, the subject A2 may not necessary to be stationary and may not be located within the capturing range.

(ii) Process for Extracting Still Portion

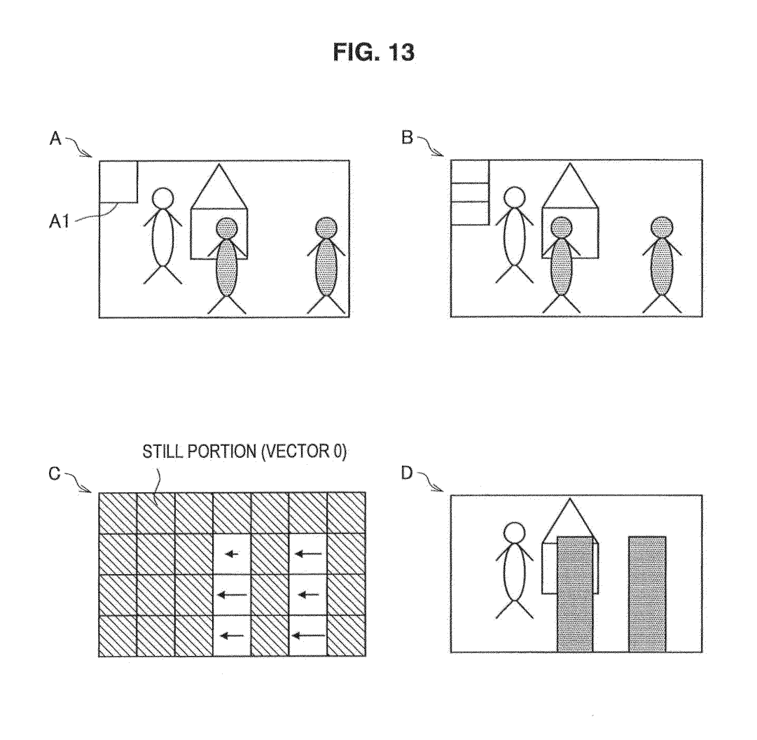

FIG. 13 is an explanatory diagram illustrating an example of the process according to the image processing method of the present embodiment. In this example, FIG. 13 illustrates a first example of the process for extracting a still portion, in the process (first still portion extraction process) of the above item (1) and the process (second still portion extraction process) of the above item (2).

The image processing apparatus according to the present embodiment divides a still image into blocks, as A1 shown in A of FIG. 13. In addition, the image processing apparatus according to the present embodiment searches for a portion having a minimum error by making the block size of another still image shown in B of FIG. 13 the same as the still image shown in A of FIG. 13. In addition, the image processing apparatus of the present embodiment searches for a portion having a minimum error in the plurality of still images as described above, and regards an amount of deviation in another still image (e.g., B shown in FIG. 13) from a position corresponding to one still image (e.g., A shown in FIG. 13) as a motion vector (C shown in FIG. 13).

The image processing apparatus of the present embodiment, when calculating a motion vector, for example, determines that a portion whose vector is 0 (zero) or a portion which is a value considered to be 0 (zero) by the threshold determination using a threshold pertaining to the absolute value of a vector is a still portion. Then, the image processing apparatus of the present embodiment extracts an image portion corresponding to a block determined to be a still portion as a still region (D shown in FIG. 13).

The image processing apparatus according to the present embodiment extracts still portions (the first still portion and second still portion) by, for example, calculating the motion vector described above, in the process (first still portion extraction process) of the above item (1) and the process (second still portion extraction process) of the above item (2), respectively. In addition, the process for extracting still portions according to the present embodiment is not limited to the process described with reference to FIG. 13.

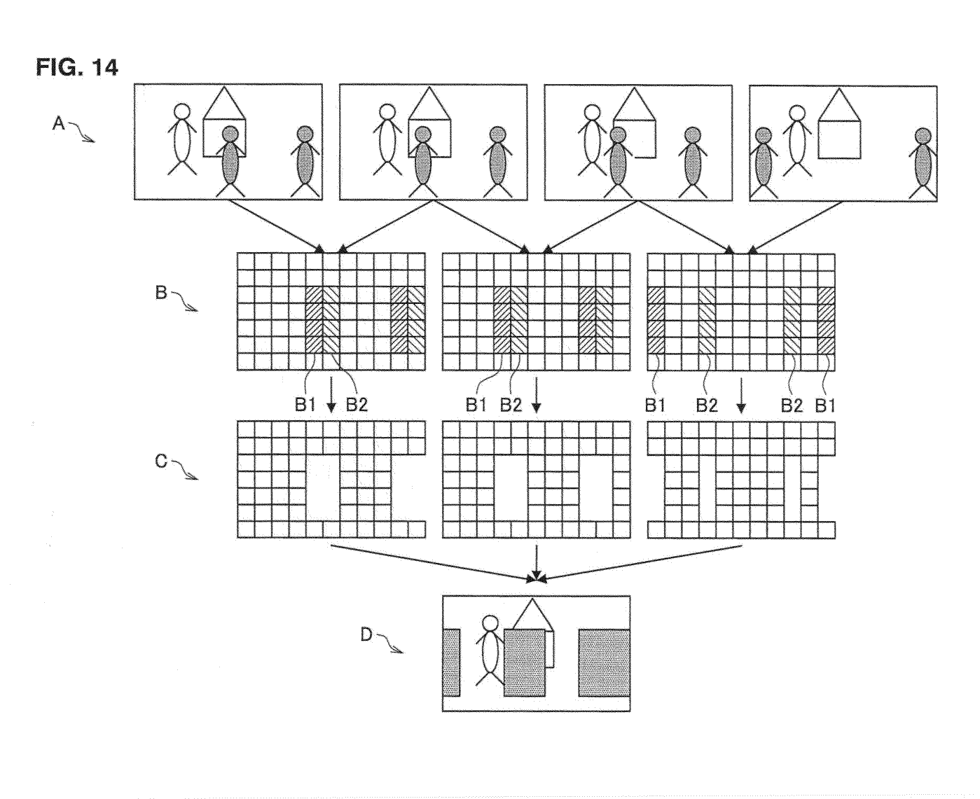

FIG. 14 is an explanatory diagram illustrating an example of the process according to the image processing method of the present embodiment. In this example, FIG. 14 illustrates a second example of the process for extracting a still portion, in the process (first still portion extraction process) of the above item (1) and the process (second still portion extraction process) of the above item (2).

Although FIG. 13 has illustrated the example of extracting the respective still portions using two still images, the image processing apparatus according to the present embodiment can extract a still portion based on three or more still images, as shown in FIG. 14. More specifically, the image processing apparatus of the present embodiment detects a motion vector to use in performing the process for the first example shown in FIG. 13 between two still images. Then, the image processing apparatus of the present embodiment extracts blocks (C and D shown in FIG. 14) from which a block with a discrepancy (B1 shown in FIG. 14) or a block with detected motion (B2 shown in FIG. 14) is removed, as a still region.

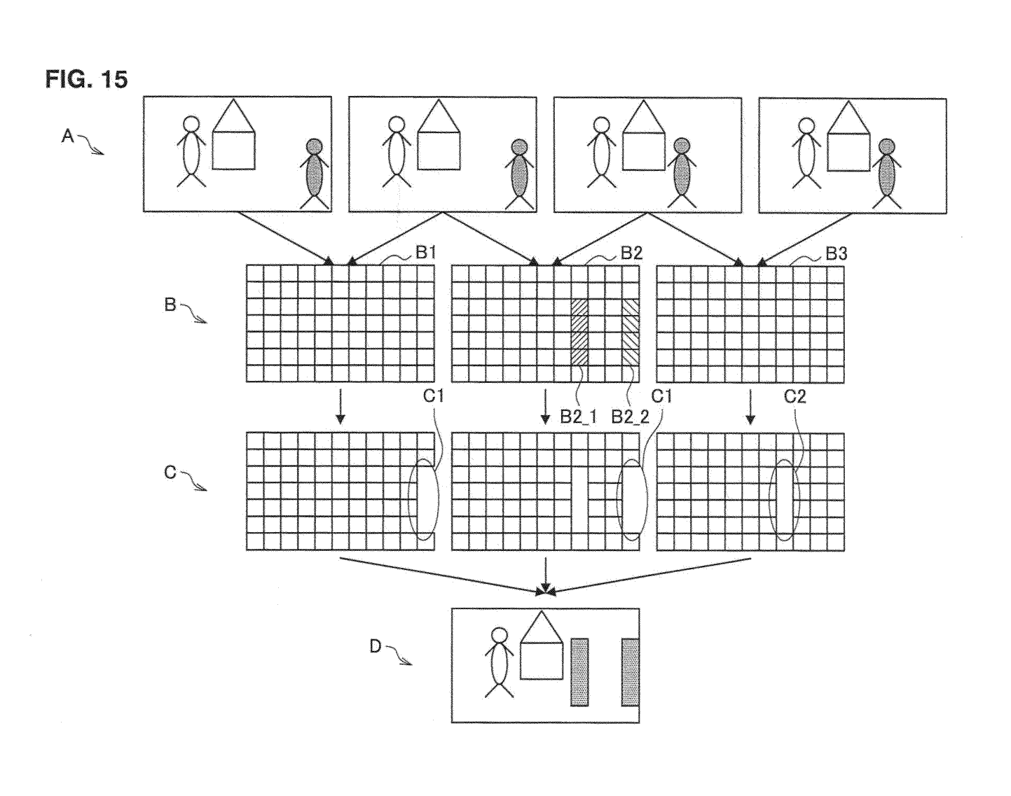

FIG. 15 is an explanatory diagram illustrating an example of the process according to the image processing method of the present embodiment. In this example, FIG. 15 illustrates a third example of the process for extracting a still portion in each of the process (first still portion extraction process) of the above item (1) and the process (second still portion extraction process) of the above item (2).

FIG. 15 illustrates another example of extracting a still portion based on three or more still images, and shows an example of processing when there is a still portion or a moving portion in a still image to be processed. Even if it is determined that there is a still portion between two still images as B1 and B3 shown in FIG. 15, a block with detected motion may be detected between any two still images, as B2 shown in FIG. 15. In a case as shown in B of FIG. 15, the image processing apparatus according to the present embodiment, for example, regards a block that moves between any particular still images as a block in which motion is detected (C shown in FIG. 15). An example of the block that moves between any particular still images may include a block determined that a block determined to be a still portion has moved (C1 of FIG. 15), a block of destination where a moved block reached (C2 of FIG. 15), and so on. Then, the image processing apparatus of the present embodiment extracts a block from which the blocks where motion is detected (C1 and C2 shown in FIG. 15) is removed, as a still region (D shown in FIG. 15).

For example, the image processing apparatus of the present embodiment can prevent a region that is moved even slightly from being extracted as a still portion by performing the process for the third example shown in FIG. 15.

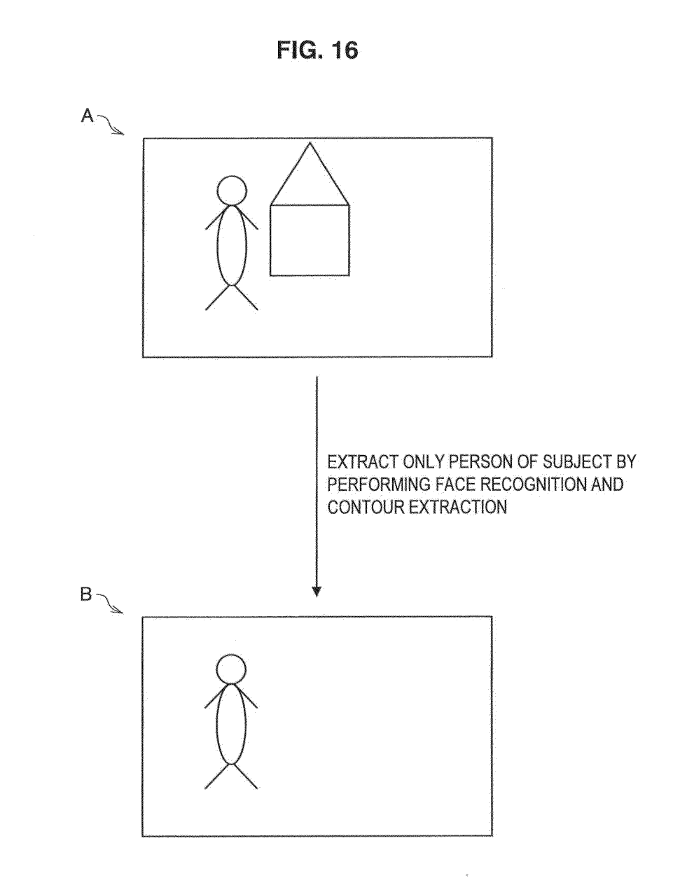

FIG. 16 is an explanatory diagram illustrating an example of the process according to the image processing method of the present embodiment. In this example, FIG. 16 illustrates a fourth example of a process for extraction of a still portion in the process (first still portion extraction process) of the above item (1).

As described above, the image processing apparatus according to the present embodiment can specify a particular subject to be extracted by performing a face detection process or contour extraction process, or by performing a process for any object recognition technology. Thus, for example even when a plurality of subjects are contained in a portion extracted as a still portion, the image processing apparatus according to the present embodiment can extract the first still portion that contains only a person of a particular subject by performing a face detection process or contour extraction process to a portion extracted as a still portion (e.g., A shown in FIG. 16).

The image processing apparatus according to the present embodiment extracts still portions (the first still portion and second still portion), for example, by performing the process for each of the first to third examples or the process for the fourth example, in the process (first still portion extraction process) of the above item (1) and the process (second still portion extraction process) of the above item (2). In addition, the process for extraction of a still portion in the image processing apparatus according to the present embodiment is not limited to the processes according to the first to fourth examples.

(iii) Deviation Correction Process

As described in the above item (ii), the image processing apparatus according to the present embodiment extracts a still portion, for example, based on the calculated motion vector, in each of the process (first still portion extraction process) of the above item (1) and the process (second still portion extraction process) of the above item (2). In this example, for example, when there are various deviations such as a vertical direction deviation, a horizontal direction deviation, or a rotation direction deviation in the still image to be processed, there is a possibility that the extraction accuracy of a still portion is deteriorated due to these various deviations.

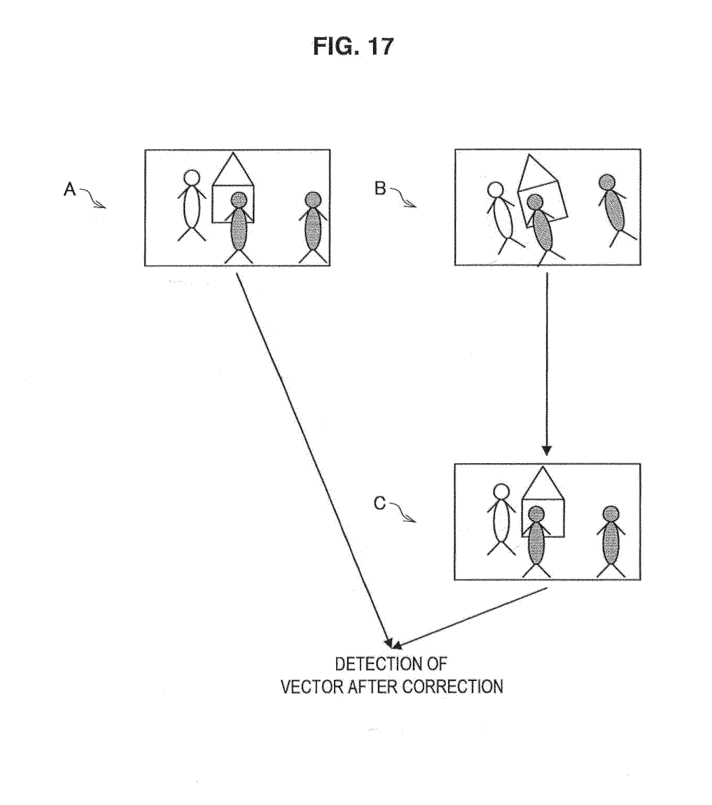

FIG. 17 is an explanatory diagram illustrating an example of the process according to the image processing method of the present embodiment. In this example, A and B shown in FIG. 17 indicates the respective examples of still images to be processed in the process (first still portion extraction process) of the above item (1) and the process (second still portion extraction process) of the above item (2).

As shown in B of FIG. 17, there may be a deviation such as a rotation direction deviation in a still image to be processed. Thus, if the process (process for extracting a still portion) of the above item (ii) is performed on an image shown in A of FIG. 17 and an image shown in B of FIG. 17 by the image processing apparatus according to the present embodiment, then the number of the extracted still portions will be smaller. This is because the motion vector including the deviation is detected.

Thus, the image processing apparatus according to the present embodiment corrects one or more deviations of the vertical direction, horizontal direction, and rotation direction in a still image to be processed (e.g., C shown in FIG. 17). This correction is performed in each of the process (first still portion extraction process) of the above item (1) and the process (second still portion extraction process) of the above item (2). Then, the image processing apparatus according to the present embodiment extracts still portions (the first still portion and second still portion) using the corrected still image.

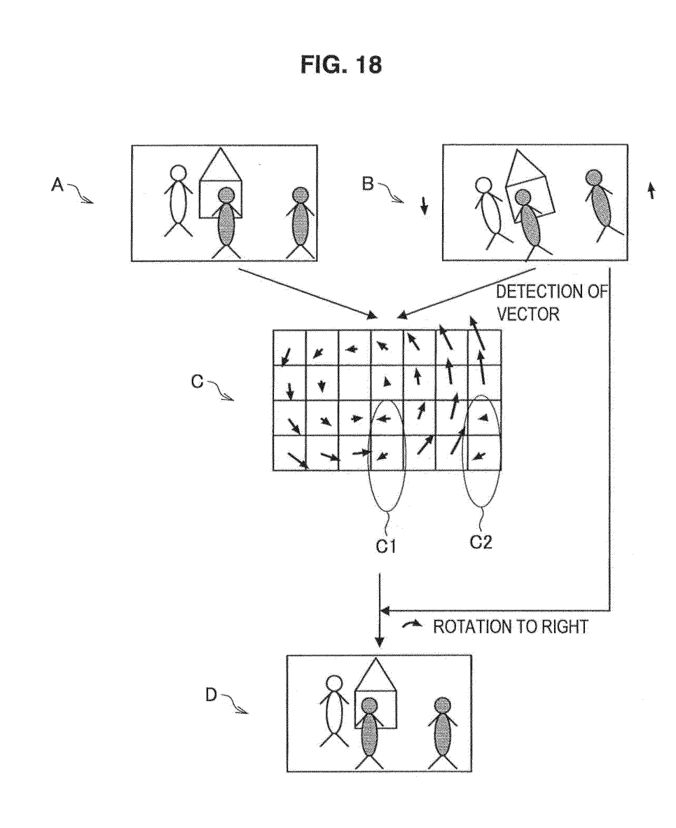

FIG. 18 is an explanatory diagram illustrating an example of the process according to the image processing method of the present embodiment, and specifically illustrates an example of a process for correcting the rotation direction deviation in accordance with the present embodiment.

The image processing apparatus according to the present embodiment calculates a motion vector (C shown in FIG. 18) based on still images to be processed (A and B shown in FIG. 18). In this example, the motion vectors of portions indicated by C1 and C2 shown in C of FIG. 18 are motion vectors due to the motion of subjects, and motion vectors of other portions are motion vectors due to a rotation direction deviation.

In this example, for example, when the still image to be processed is the image captured by an image pickup device, the motion vector due to various deviations such as a rotation direction deviation depends on a motion that would occurred in the image pickup device. Thus, the image processing apparatus according to the present embodiment calculates the rotation angle, center, and shift amount with a plurality of vector values indicating one motion (the rotation angle is calculates in the example of FIG. 18), and corrects an image shown in B of FIG. 18 which is a still image to be processed based on the calculated value (D shown in FIG. 18).

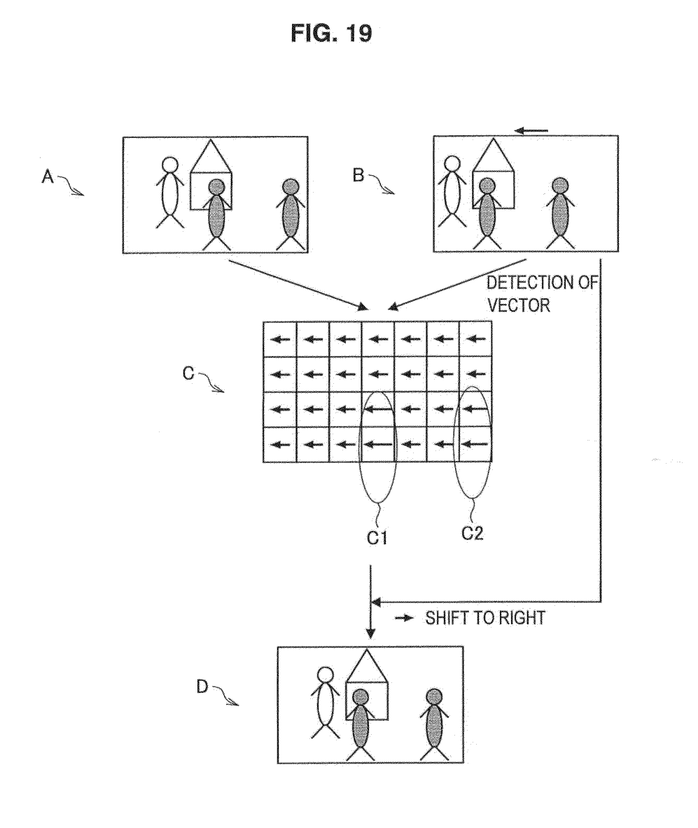

FIG. 19 is an explanatory diagram illustrating an example of the process according to the image processing method of the present embodiment, and specifically illustrates an example of a process for correcting the horizontal direction deviation in accordance with the present embodiment.

The image processing apparatus according to the present embodiment calculates the motion vector (C shown in FIG. 19) based on still images to be processed (A and B shown in FIG. 19). In this example, the motion vectors of portions corresponding to C 1 and C2 shown in C of FIG. 19 are motion vectors due to the motion of a subject, and the motion vectors of other portions are motion vectors due to a horizontal direction deviation.

In this example, for example, when the still image to be processed is an image captured by an image pickup device, the motion vector due to various deviations such as a horizontal direction deviation depends on a motion that would occurred in the image pickup device. Thus, the image processing apparatus according to the present embodiment calculates the rotation angle, center, and shift amount with a plurality of vector values indicating one motion (the shift amount is calculates in the example of FIG. 19), and corrects an image shown in B of FIG. 19 which is a still image to be processed based on the calculated value (D shown in FIG. 19).

The image processing apparatus according to the present embodiment, for example, corrects one or more deviations of the vertical direction, horizontal direction, and rotation direction in the still image to be processed, as shown in FIGS. 18 and 19. Then, the image processing apparatus according to the present embodiment extracts still portions (the first still portion and second still portion) using the corrected still image. In addition, the image processing apparatus according to the present embodiment may correct the deviations as described above, for example, based on results detected by a shake detection sensor (e.g., an angular velocity sensor provided in an image pickup device for correcting blurring or camera shake) as well as the motion vector.

(iv) Noise Reduction Process

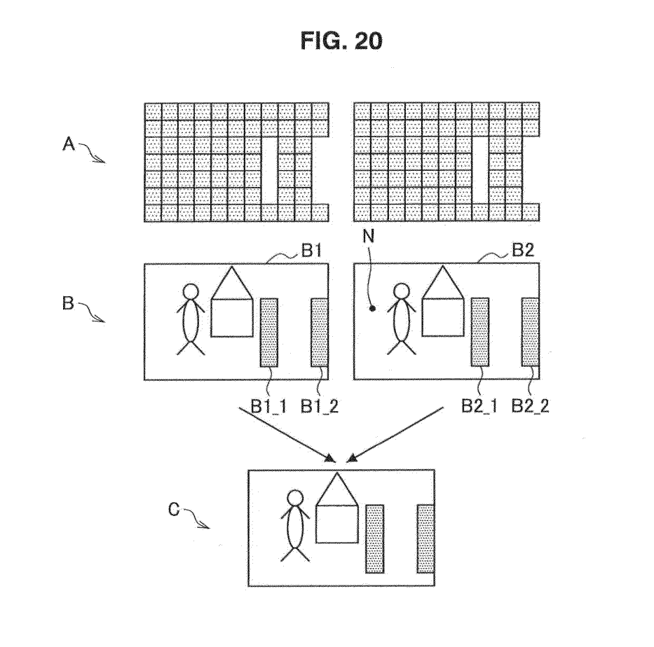

FIG. 20 is an explanatory diagram illustrating an example of the process according to the image processing method of the present embodiment.

In the process (first still portion extraction process) of the above item (1) and the process (second still portion extraction process) of the above item (2) according to the image processing method of the present embodiment, as described above, the still portion is extracted, for example, by using the motion vector. Thus, for example, a portion that can be determined to have a high degree of coincidence by a motion vector is likely to be extracted from among a plurality of still images. In other words, for example, when a frame image constituting a moving image is a still image to be processed, there may be a plurality of still images that contain the extracted still portions (first still portion and second still portion) of a plurality of still images to be processed.

In addition, when there is a plurality of still images that contain the extracted still portions (first still portion and second still portion) (e.g., B1 and B2 shown in FIG. 20), any one of the still images may have a noise N (e.g., B2 shown in B of FIG. 20).

In this example, for example, in the process (first still portion extraction process) of the above item (1), when a plurality of still images which contains the extracted first still portion is included in the plurality of still images to be processed, the image processing apparatus according to the present embodiment performs an addition of the plurality of still images. More specifically, in the above case, the image processing apparatus according to the present embodiment, for example, regards an image indicating a signal obtained by averaging a signal that corresponds to a region corresponding to the first still portion in the plurality of still images, as the first still portion.

For example, as described above, the image processing apparatus according to the present embodiment can reduce a noise, for example, as shown in B2 of FIG. 20, by adding the plurality of still images in the process (first still portion extraction process) of the above item (1).

Further, the image processing apparatus according to the present embodiment can perform a process which is similar to the noise reduction process performed in the process (first still portion extraction process) of the above item (1), for example, in the process (second still portion extraction process) of the above item (2).

(v) Processing Time Control Process in First Still Portion Extraction Process

For example, in a case where the image processing apparatus according to the present embodiment has image pickup function and obtains a plurality of still images to be processed in the process (first still portion extraction process) of the above item (1) by image capturing, the image processing apparatus according to the present embodiment may perform a processing time control process for controlling a processing time in the process (first still portion extraction process) of the above item (1) by controlling the image capturing.

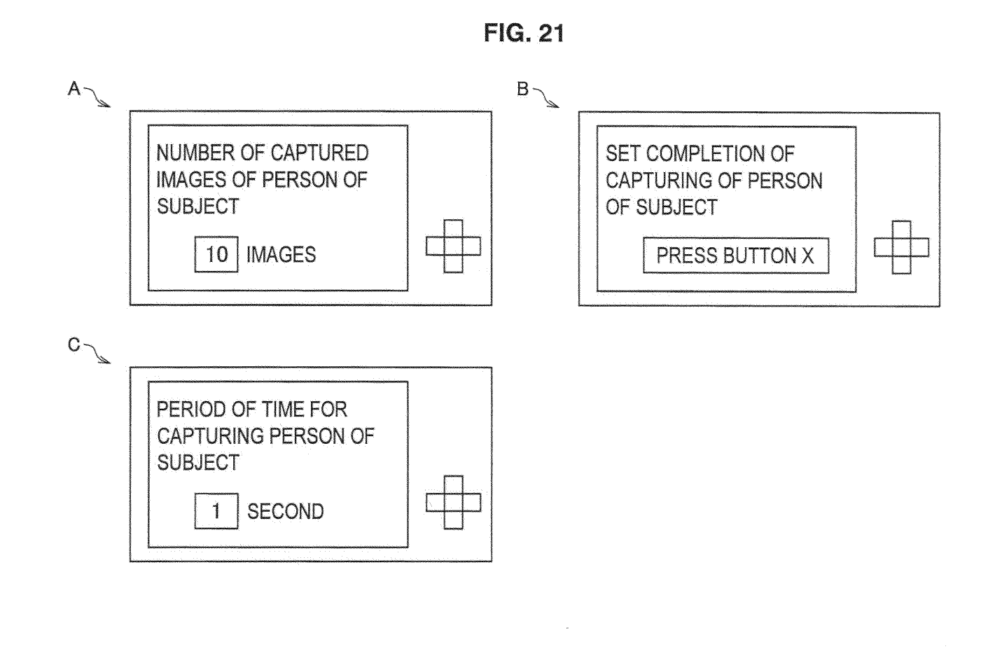

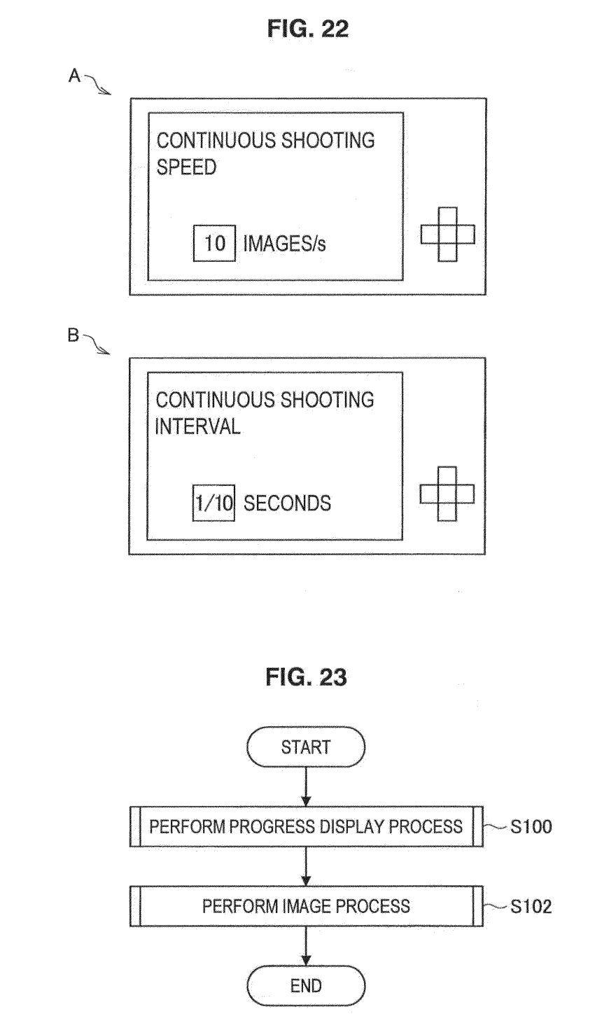

FIGS. 21 and 22 are explanatory diagrams illustrating an exemplary process performed by the image processing method according to the present embodiment, and illustrate examples of the processing time control process according to the present embodiment.

FIG. 21 illustrates an example of controlling a processing time in the process (first still portion extraction process) of the above item (1), based on a predetermined setting value or a setting value set in response to a user operation (A and C shown in FIG. 21, respectively), or based on the user operation (B shown in FIG. 21). For example, the image processing apparatus according to the present embodiment terminates the process (first still portion extraction process) of the above item (1) when the number of the captured image reaches ten frames of image (A shown in FIG. 21). Alternatively, the image processing apparatus according to the present embodiment terminates the process (first still portion extraction process) of the above item (1) after one second has elapsed from the start of capturing (B shown in FIG. 21). In addition, the image processing apparatus according to the present embodiment terminates the process (first still portion extraction process) of the above item (1), for example, when it is detected that a user performs a particular operation (C shown in FIG. 21). In this example, in a case where a user performs a particular operation in an external device, the image processing apparatus according to the present embodiment, for example, when receiving an operation signal indicating that the particular operation was performed from the external device, detects that the user performed the particular operation.

Moreover, the processing time control process according to the present embodiment is not limited to, for example, the examples performed based on the setting value or user operation as shown in FIG. 21. For example, the image processing apparatus according to the present embodiment may automatically terminate the process (first still portion extraction process) of the above item (1), by a threshold process that uses a value of motion amount obtained by detection of a motion vector and a predetermined threshold. In this example, the predetermined threshold may be a predefined fixed value, or may be a user-adjustable variable value.

Furthermore, for example, there may be a case where the image processing apparatus according to the present embodiment terminates the process (first still portion extraction process) of the above item (1) when it is detected that a user performed a particular operation as shown in B of FIG. 21. In this case, the progress of the process may be displayed on a display screen by sing the display control process according to the present embodiment. This progress display according to the present embodiment makes it possible for a user to perform a particular operation while visually recognizing the progress of the process.

FIG. 22 illustrates configurations according to the image capturing. A continuous shooting speed as shown in A of FIG. 22 or a continuous shooting interval as shown in B of FIG. 22 is predefined or is set by a user operation. This makes it possible to control an image obtained for a certain period of time, and a processing time in the process (first still portion extraction process) of the above item (1) is indirectly controlled. In addition, the processing time control process according to the present embodiment is not limited to, for example, an example performed based on the setting value as shown in FIG. 22. For example, the image processing apparatus according to the present embodiment may control the continuous shooting speed or continuous shooting interval (control of image capturing) by a threshold process that uses a value of motion amount obtained by detection of a motion vector and a predetermined threshold.

The image processing apparatus according to the present embodiment performs, for example, the processes described in the above items (i) to (v) in the above-mentioned process according to the image processing method of the present embodiment. In addition, the processes performed in the process according to the image processing method of the present embodiment are not limited to those described in the above items (i) to (v).

[4] Process According to Image Processing Method of Present Embodiment

Next, an example of the process according to the image processing method of the present embodiment will be described in more detail. FIG. 23 is a flowchart illustrating an example of the process according to the image processing method of the present embodiment. The process according to the image processing method of the present embodiment shown in FIG. 23 will be described hereinafter by taking as an example a case where the image processing apparatus of the present embodiment performs the process. In addition, FIG. 23 illustrates an example that the image processing apparatus according to the present embodiment performs the process using a plurality of still images to be processed after a progress display is performed by using a reduced image corresponding to the plurality of still images to be processed.

The image processing apparatus according to the present embodiment performs a progress display process (S100).

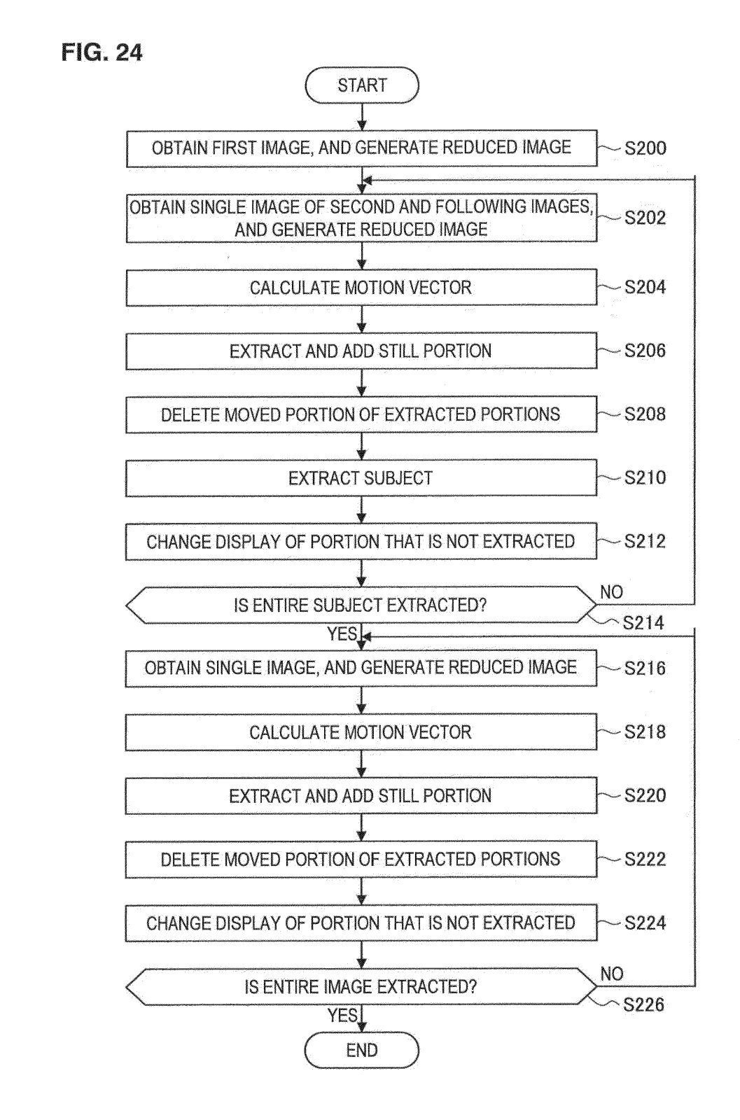

FIG. 24 is a flowchart illustrating an example of the progress display process according to the image processing method of the present embodiment. In this example, processes in steps S200 to S210 of FIG. 24 correspond to the process (first still portion extraction process) of the above item (1), the process (combined image generation process) of the above item (3), and the display control process according to the present embodiment. In addition, the processes in steps S200 to S210 of FIG. 24 correspond to the process performed in the “period of time for extraction of subject O” shown in FIG. 5. In addition, processes performed in steps S216 to S222 of FIG. 24 correspond to the process (second still portion extraction process) of the above item (2), the process (combined image generation process) of the above item (3), and the display control process according to the present embodiment.

The image processing apparatus according to the present embodiment obtains a first frame of image to be processed and generates a reduced image of the image (S200). In this example, the image processing apparatus according to the present embodiment generates the reduced image, for example, by a resize process for changing a size of the image to a the set image size (size of the image to be processed>the set image size). In addition, the image processing apparatus according to the present embodiment can use any resize process for changing a size of the image to be processed to the set image size.

The image processing apparatus according to the present embodiment obtains a second frame of image to be processed, and generates a reduced image of the image in a similar way to step S200 (S202).

When steps S200 and S202 are completed, the image processing apparatus according to the present embodiment calculates a motion vector based on the generated reduced image (S204). In this example, the image processing apparatus according to the present embodiment, in step S204, calculates the motion vector by dividing the reduced image into blocks, for example, as described with reference to FIG. 13.

The image processing apparatus according to the present embodiment extracts a still portion based on the motion vector calculated in step S204, and if there is a previously extracted portion, adds the extracted still portion (S206). Additionally, the image processing apparatus according to the present embodiment deletes a portion determined that it has moved based on the motion vector from among the portions extracted in step S206 (S208). In this example, the process in step S208 corresponds to, for example, the process described with reference to FIG. 15.

The image processing apparatus according to the present embodiment extracts a particular subject to be extracted, for example, by performing a face detection process, contour extraction process, and so on (S210).

The image processing apparatus according to the present embodiment changes a display of the portion that has not been extracted as a still portion (first still portion) of an image, and causes the image indicating the extracted still portion (first still portion) to be displayed on a display screen (S212). In this case, an example of the method of changing the display in step S212 includes, for example, the methods illustrated in FIGS. 9 and 11.

When the process in step S212 is performed, the image processing apparatus according to the present embodiment determines whether the entire particular subject to be extracted is extracted (S214). In this example, when it is determined that the entire contour of a particular subject is extracted, for example, based on a result obtained from the contour extraction process or the like, the image processing apparatus according to the present embodiment determines that the entire particular subject is extracted.

When it is not determined that the entire particular subject to be extracted is extracted in step S214, the image processing apparatus according to the present embodiment repeats the process from step S202.

Furthermore, when it is determined that the entire particular subject to be extracted is extracted in step S214, the image processing apparatus according to the present embodiment obtains single frame of the image to be processed, and generates a reduced image of the image, in a similar way to step S200 (S216).

When the process in step S216 is completed, the image processing apparatus according to the present embodiment calculates a motion vector based on the generated reduced image, in a similar way to step S204 (S218).

The image processing apparatus according to the present embodiment extracts a still portion based on the motion vector calculated in step S218, and adds a newly extracted still portion to the previously extracted still portion (S220). In addition, the image processing apparatus according to the present embodiment deletes a portion determined that it has moved on the basis of the motion vector from among the portions extracted in step S220 in a similar way to step S208 (S222).

The image processing apparatus according to the present embodiment changes a display of the portion not extracted as the still portion (the first still portion and second still portion) of an image, and causes the image indicating the extracted still portions (the first still portion and second still portion) to be displayed on a display screen (S224). In this example, an example of the method of changing the display in step S224 includes, for example, the methods illustrated in FIGS. 9 and 11.

When the process in step S224 is performed, the image processing apparatus according to the present embodiment determines whether the entire image is extracted (S226). In this example, when there is no portion contained in either of the first still portion or the second still portion of an image, the image processing apparatus according to the present embodiment determines that the entire image is extracted.

When it is not determined that the entire particular subject to be extracted is extracted in step S226, the image processing apparatus according to the present embodiment repeats the process from step S216. In addition, when it is determined that the entire image is extracted in step S226, the image processing apparatus according to the present embodiment terminates the progress display process according to the present embodiment.

The image processing apparatus according to the present embodiment performs, for example, the process illustrated in FIG. 24 as the progress display process illustrated in step 100 of FIG. 23. In addition, the progress display process according to the present embodiment is not limited to the example illustrated in FIG. 24. For example, the image processing apparatus according to the present embodiment may not perform the process illustrated in step S210 of FIG. 24.

Referring again to FIG. 23, an example of the process according to the image processing method of the present embodiment will be described. When the process in step S100 is completed, the image processing apparatus according to the present embodiment performs an image process using a plurality of still images to be processed (S102). When the process in step S102 is completed, the image processing apparatus according to the present embodiment terminates the process according to the image processing method of the present embodiment.

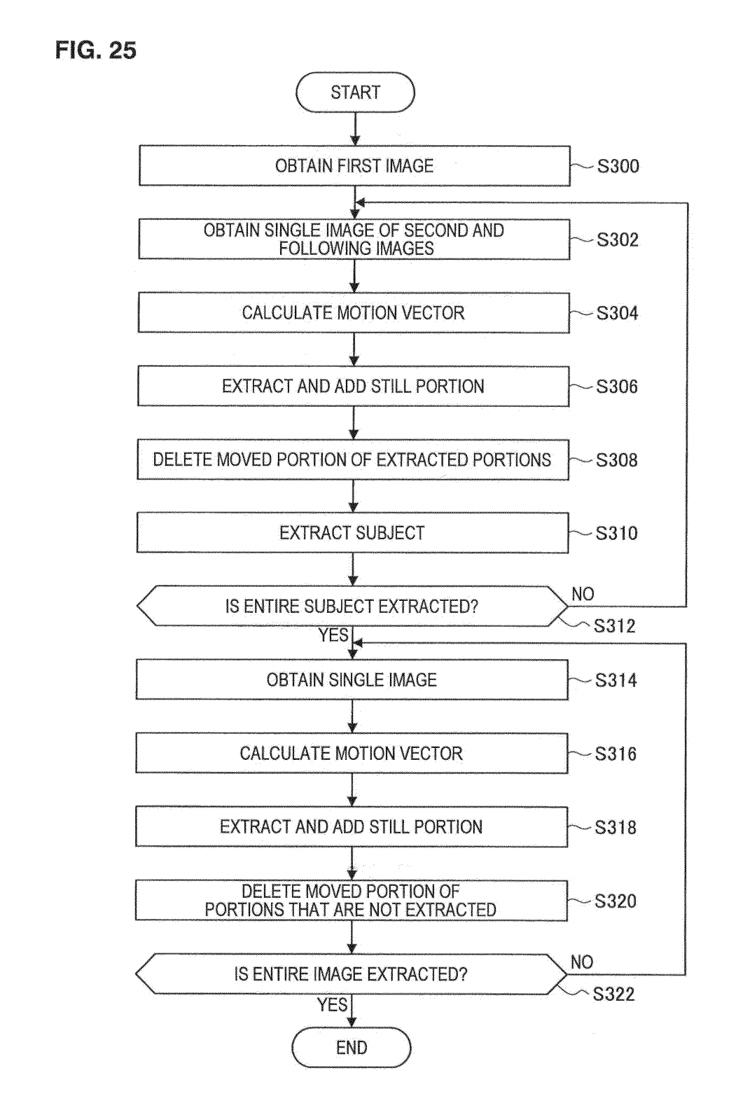

FIG. 25 is a flowchart illustrating an example of the progress display process according to the image processing method of the present embodiment. In this example, processes in steps S300 to S310 of FIG. 25 correspond to the process (first still portion extraction process) of the above item (1), the process (combined image generation process) of the above item (3), and the display control process according to the present embodiment. In addition, processes in steps S316 to S322 of FIG. 25 correspond to the process (second still portion extraction process) of the above item (2), the process (combined image generation process) of the above item (3), and the display control process according to the present embodiment.

The image processing apparatus according to the present embodiment obtains a first frame of image to be processed (S300). In this case, the image obtained in step S300 is an image that corresponds to the reduced image generated in step S200 of FIG. 24.

The image processing apparatus according to the present embodiment obtains a single image of the second and the following frames of image to be processed (S302). In this case, the image obtained in step S302 is an image that corresponds to the reduced image generated in step S202 of FIG. 24.

When the processes in steps S300 and S302 are completed, the image processing apparatus according to the present embodiment calculates a motion vector based on the obtained images, in a similar way to step S204 of FIG. 24 (S304).

The image processing apparatus according to the present embodiment extracts a still portion based on the motion vector calculated in step S304, and if there is a previously extracted portion, adds the extracted still portion (S306). In addition, the image processing apparatus according to the present embodiment deletes a portion determined that it has moved based on the motion vector from among the portions extracted in step S306 in a similar way to step S208 of FIG. 24 (S308).

The image processing apparatus according to the present embodiment extracts a particular subject to be extracted, for example, by performing the face detection process, contour extraction process, or the like (S310).

When the process in step S310 is performed, the image processing apparatus according to the present embodiment determines whether the entire particular subject to be extracted is extracted in a similar way to step S214 of FIG. 24 (S312). When it is not determined that the entire particular subject to be extracted in step S312, the image processing apparatus according to the present embodiment repeats the process from step S302.

Furthermore, when it is determined that the entire particular subject to be extracted is extracted in step S312, the image processing apparatus according to the present embodiment obtains single frame of the image to be processed (S314). In this case, the image obtained in step S300 is an image that corresponds to the reduced image generated in step S216 of FIG. 24.

When the process in step S314 is completed, the image processing apparatus according to the present embodiment calculates a motion vector based on the obtained image in a similar way to step S304 (S316).

The image processing apparatus according to the present embodiment extracts a still portion based on the motion vector calculated in step S316, and adds a newly extracted still portion to the previously extracted still portion (S318). In addition, the image processing apparatus according to the present embodiment deletes a portion determined that it has moved based on the motion vector from among the portions extracted in step S318 in a similar way to step S308 (S320).

When the process in step 320 is performed, the image processing apparatus according to the present embodiment determines whether the entire image is extracted (S322). In this case, when there is no portion that is not contained in either of the first still portion or the second still portion in an image, the image processing apparatus according to the present embodiment determines that the entire image is extracted.

When it is not determined that the entire particular subject to be extracted is extracted in step S322, the image processing apparatus according to the present embodiment repeats the process from step S314. In addition, when it is determined that the entire image is extracted in step S322, the image processing apparatus according to the present embodiment terminates the image process according to the present embodiment.

The image processing apparatus according to the present embodiment performs, for example, the process illustrated in FIG. 25 as the image process illustrated in step S102 of FIG. 23. In addition, the image processing apparatus according to the present embodiment is not limited to the example illustrated in FIG. 25. For example, the image processing apparatus according to the present embodiment may not perform the process of step S310 illustrated in FIG. 25.

The image processing apparatus according to the present embodiment performs, for example, the process illustrated in FIG. 23 as the process according to the image processing method of the present embodiment. In addition, the process according to the image processing method of the present embodiment is not limited to the process illustrated in FIG. 23. For example, FIG. 23 illustrates the example that the image processing apparatus according to the present embodiment performs the progress display process for displaying the reduced image on a display screen and the image process based on the image to be processed. However, the image processing apparatus according to the present embodiment may display the progress of the image process on a display screen, while performing the image process based on the image to be processed.

(Image Processing Apparatus According to Present Embodiment)

Next, an example of the configuration of the image processing apparatus according to the present embodiment capable of performing the process according to the image processing method of the present embodiment described above will be described.

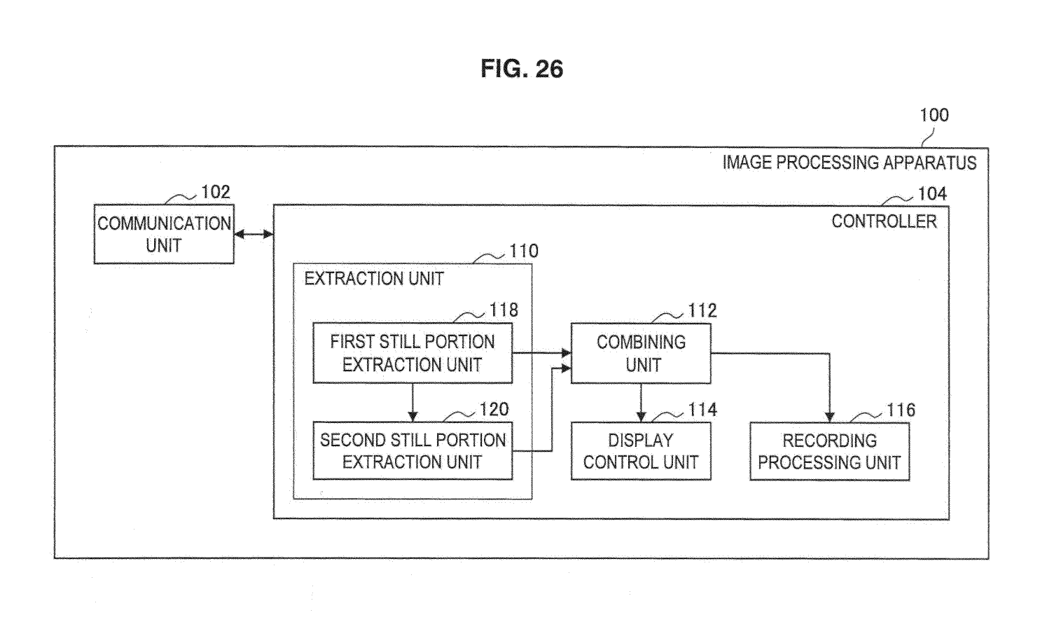

FIG. 26 is a block diagram illustrating an exemplary configuration of an image processing apparatus 100 according to the present embodiment. The image processing apparatus 100 includes, for example, a communication unit 102 and a controller 104.

Further, the image processing apparatus 100 may include, for example, a ROM (Read Only Memory, not shown), a RAM (not shown), a storage unit (not shown), an operation unit operable by a user (not shown), a display unit for displaying various screens on a display screen (not shown), and so on. The image processing apparatus 100 connects, for example, between the above-mentioned respective components via a bus that functions as a data transmission path.

In this example, the ROM (not shown) stores control data such as a program or operation parameter used by the controller 104. The RAM (not shown) temporarily stores a program or the like executed by the controller 104.

The storage unit (not shown) is a storage device provided in the image processing apparatus 100, and stores a variety of data such as image data or applications. In this example, an example of the storage unit (not shown) may include, for example, a magnetic recording medium such as a hard disk, and a nonvolatile memory such as an EEPROM (Electrically Erasable and Programmable Read Only Memory) and a flash memory. In addition, the storage unit (not shown) may be removable from the image processing apparatus 100.

[Exemplary Hardware Configuration of Image Processing Apparatus 100]

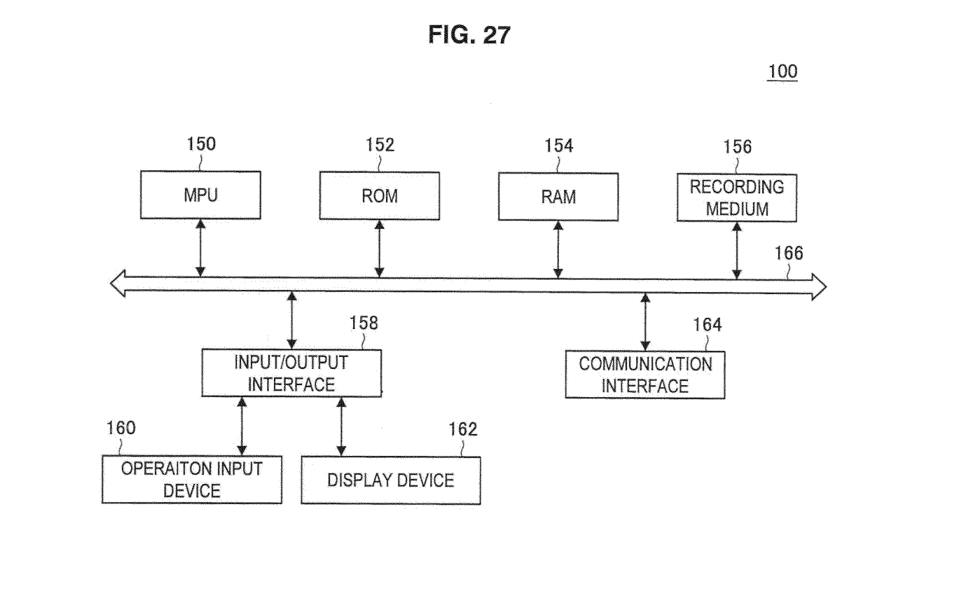

FIG. 27 is an explanatory diagram illustrating an exemplary hardware configuration of the image processing apparatus 100 according to the present embodiment. The image processing apparatus 100 includes, for example, an MPU 150, a ROM 152, a RAM 154, a recording medium 156, an input/output interface 158, an operation input device 160, a display device 162, and a communication interface 164. In addition, for example, the image processing apparatus 100 connects between the respective constituent elements via a bus 166 serving as a data transmission path.

The MPU 150 functions, for example, as the controller 104 for controlling the entire image processing apparatus 100 configured to include a MPU (Micro Processing Unit), various processing circuits, or the like. Additionally, in the image processing apparatus 100, the MPU 150 functions as an extraction unit 110, a combining unit 112, a display control unit 114, and a recording processing unit 116, which are described later.

The ROM 152 stores control data such as a program or operation parameter used by the MPU 150. The RAM 154 temporarily stores, for example, a program or the like executed by the MPU 150.

The recording medium 156 functions as a storage unit (not shown), and stores, for example, various data such as applications and data constituting an image to be operated. In this example, an example of the recording medium 156 may include, for example, a magnetic recording medium such as a hard disk and a nonvolatile memory such as a flash memory. In addition, the recording medium 156 may be removable from the image processing apparatus 100.

The input/output interface 158 is connected to, for example, the operation input device 160 and the display device 162. The operation input device 160 functions as an operation unit (not shown). The display device 162 functions as a display unit (not shown). In this example, an example of the input/output interface 158 may include, for example, a USB (Universal Serial Bus) terminal, a DVI (Digital Visual Interface) terminal, a HDMI (High-Definition Multimedia Interface) terminal, various processing circuits, and so on. In addition, the operation input device 160 is provided on the image processing apparatus 100, and is connected to the input/output interface 158 within the image processing apparatus 100. An example of the operation input device 160 may include, for example, a button, a direction key, a rotational selector such as a jog dial, or combination thereof. In addition, for example, the display device 162 is provided on the image processing apparatus 100, and is connected to the input/output interface 158 within the image processing apparatus 100. An example of the display device 162 may include, for example, a liquid crystal display (LCD), an organic EL display (organic Electro-Luminescence display; referred often to as an OLED display (Organic Light Emitting Diode display)), and so on.

Further, the input/output interface 158 may be connected to an external device such as an operation input device (e.g., a keyboard or mouse) or a display device that serves as an external equipment of the image processing apparatus 100. In addition, the display device 162 may be, for example, a device that can display information and be operated by a user, such as a touch screen.

The communication interface 164 is a communication appliance provided in the image processing apparatus 100, and functions as the communication unit 102 for performing communication with an external device such as an image pickup device or a display device via a network (or directly) on a wired or wireless connection. In this example, an example of the communication interface 164 may include a communication antenna and RF (radio frequency) circuit (wireless communication), an IEEE 802.15.1 port and transmission/reception circuit (wireless communication), an IEEE 802.11b port and transmission/reception circuit (wireless communication), a LAN (Local Area Network) terminal and transmission/reception circuit (wired communication), and so on. In addition, an example of the network according to the present embodiment may include a wired network such as a LAN or WAN (Wide Area Network), a wireless network such as a wireless LAN (WLAN: Wireless Local Area Network) or a wireless WAN (WWAN: Wireless Wide Area Network) via a base station, and the Internet using a communication protocol such as a TCP/IP (Transmission Control Protocol/Internet Protocol).

The image processing apparatus 100 performs, for example, the process according to the image processing method of the present embodiment by means of the configuration shown in FIG. 27. In addition, the hardware configuration of the image processing apparatus 100 according to the present embodiment is not limited to the configuration shown in FIG. 27. For example, the image processing apparatus 100 may include an image pickup device that serves as an image pickup unit (not shown) for capturing a still image or moving image. The image processing apparatus 100, when including an image pickup device, can perform the process according to the image processing method of the present embodiment, for example, based on the captured image generated by capturing in the image pickup device.

In this example, an example of the image pickup device may include a lens/imaging element and a signal processing circuit. The lens/imaging element is configured to include an optical lens and an image sensor that uses a plurality of imaging elements such as a CMOS (Complementary Metal Oxide Semiconductor). In addition, the signal processing circuit may include an AGC (Automatic Gain Control) circuit or ADC (Analog to Digital Converter). The signal processing circuit converts analog signals generated by the imaging elements into digital signals (image data), and performs various types of signal processing. An example of the signal processing performed by the signal processing circuit may include White Balance correction process, color tone correction process, gamma correction process, YCbCr conversion process, edge enhancement process, and so on.

Furthermore, for example, when the image processing apparatus 100 is configured to perform the process on a stand-alone basis, the image processing apparatus 100 may not include the communication interface 164. In addition, the image processing apparatus 100 may be configured without the operation input device 160 or the display device 162.

Referring again to FIG. 26, an example of the configuration of the image processing apparatus 100 will be described. The communication unit 102 is a communication appliance provided in the image processing apparatus 100, and performs a communication with an external device such as an image pickup device or display device via a network (or directly) on a wired or wireless connection. In addition, the communication performed by the communication unit 102 is controlled by, for example, the controller 104.

The presence of the communication unit 102 in the image processing apparatus 100 makes it possible for the image processing apparatus 100 to receive data indicating an image captured in an image pickup device as an external device or data indicating an image stored in an external device (e.g., a server, a user terminal such as a mobile phone or smart phone, and so on), and process an image indicated by the received data. In addition, the image processing apparatus 100 may transmit, for example, the processed image (combined image) to an external device. Thus, The presence of the communication unit 102 in the image processing apparatus 100 makes it possible to realize an image processing system including the image processing apparatus 100 and an external device (an image pickup device, a server, a user terminal such as a mobile phone or smart phone). In addition, the realization of the image processing system makes it possible to reduce the processing load on the external device, because, for example, the external device such as a user terminal may not perform the process according to the image processing method of the present embodiment.

In this example, an example of the communication unit 102 may include a communication antenna and RF circuit, a LAN terminal and transmission/reception circuit, and so on, but the configuration of the communication unit 102 is not limited thereto. For example, the communication unit 102 may have a configuration corresponding to any standard capable of performing a communication, such as a USB port and transmission/reception circuit, or a configuration capable of communicating with an external device via a network.

The controller 104 is configured to include, for example, a MPU or various processing circuits, and controls the entire image processing apparatus 100. In addition, the controller 104 may include an extraction unit 110, a combining unit 112, a display control unit 114, and a recording processing unit 116. The controller 104 plays a leading role in controlling the process according to the image processing method of the present embodiment.

The extraction unit 110 plays a leading role in performing the process (first still portion extraction process) of the above item (1) and the process (second still portion extraction process) of the above item (2). The extraction unit 110 extracts a first still portion based on a plurality of still images, and extracts at least a part of a second still portion based on the plurality of still images. In addition, the extraction unit 110 includes, for example, a first still portion extraction unit 118 and a second still portion extraction unit 120.

The first still portion extraction unit 118 plays a leading role in performing the process (first still portion extraction process) of the above item (1), and extracts the first still portion in an image based on the plurality of still images. In this example, the still image processed by the first still portion extraction unit 118 may be one or more of an image captured by an image pickup device, a still image stored in a recording medium, and a frame image partially constituting an moving image stored in a recording medium. In addition, when the image processing apparatus 100 includes an image pickup device, the first still portion extraction unit 118 may process an image captured by the image pickup device. In other words, when the image captured by the image pickup device is processed, the image processing apparatus 100 can process the image captured by the image processing apparatus itself that functions as the image pickup device.

Further, the first still portion extraction unit 118 transmits, for example, data indicating the extracted first still portion to the second still portion extraction unit 120 and the combining unit 112.

Moreover, when the image processing apparatus 100 causes a progress display based on a reduced image to be displayed on a display screen as the display control process according to the present embodiment, the first still portion extraction unit 118 may, for example, generate a reduced image of the still image to be processed, and extract a first still portion corresponding to the reduced image. In this case, the first still portion extraction unit 118 transmits, for example, data indicating the first still portion corresponding to the extracted reduced image to the second still portion extraction unit 120 and the combining unit 112.

The second still portion extraction unit 120 plays a leading role in performing the process (second still portion extraction process) of the above item (2), and extracts a second still portion in an image based on a plurality of still images. In this example, an example of the still image processed by the second still portion extraction unit 120 may include one or more of an image captured by an image pickup device, a still image stored in a recording medium, and a frame image partially constituting an moving image stored in a recording medium. In addition, when the image processing apparatus 100 includes an image pickup device, the second still portion extraction unit 120 may process an image captured by the image pickup device, in a similar manner to the first still portion extraction unit 118.

Further, the second still portion extraction unit 120 transmits, for example, data indicating the extracted second still portion to the combining unit 112.

Furthermore, when a progress display based on a reduced image is displayed on a display screen by performing the display control process according to the present embodiment in the image processing apparatus 100, the second still portion extraction unit 120 may, for example, generate a reduced image of the still image to be processed, and extract a second still portion corresponding to the reduced image. In this case, for example, on the basis of a reduced image in which the still image to be processed is reduced each time the number of the still images to be processed increases, the second still portion extraction unit 120 extracts a new second still portion corresponding to the reduced image. In addition, the second still portion extraction unit 120 may transmit, for example, data indicating the second still portion corresponding to the extracted reduced image to the combining unit 112.

The extraction unit 110 includes, for example, the first still portion extraction unit 118 and the second still portion extraction unit 120, and thus plays a leading role in performing the process (first still portion extraction process) of the above item (1) and the process (second still portion extraction process) of the above item (2). In addition, FIG. 26 illustrates an exemplary configuration that the controller 104 includes the extraction unit 110 that plays a leading role in performing the process (first still portion extraction process) of the above item (1) and the process (second still portion extraction process) of the above item (2). However, the image processing apparatus according to the present embodiment is not limited to the above example. For example, the image processing apparatus according to the present embodiment may include the first still portion extraction unit 118 and the second still portion extraction unit 120 as separate components from each other (e.g., different processing circuits from each other). In this case, the first still portion extraction unit 118 plays a leading role in performing the process (first still portion extraction process) of the above item (1), and the second still portion extraction unit 120 plays a leading role in performing the process (second still portion extraction process) of the above item (2).

The combining unit 112 plays a leading role in performing the process (combined image generation process) of the above item (3). In addition, the combining unit 112 combines the first still portion indicated by data transmitted from the first still portion extraction unit 118 and the second still portion indicated by data transmitted from the second still portion extraction unit 120 to generate a combined image.

Further, when the image processing apparatus 100 performs the display control process according to the present embodiment so that a progress display based on a reduced image is displayed on a display screen, the combining unit 112 may combine the first still portion corresponding to the reduced image and the second still portion corresponding to the reduced image, and then generate a combined image corresponding to the reduced image. In this case, for example, each time a new second still portion corresponding to the reduced image is extracted in the second still portion extraction unit 120, the combining unit 112 may combine the first still portion corresponding to the reduced image or the previously generated combined image corresponding to the reduced image and a newly extracted second still portion corresponding to the reduced image, and then generate a new combined image corresponding to the reduced image.

Furthermore, the combining unit 112 transmits, for example, data indicating the combined image to the display control unit 114.

Moreover, the combining unit 112 transmits, for example, the generated combined image to the recording processing unit 116.

The display control unit 114 plays a leading role in performing the display control process according to the image processing method of the present embodiment, and allows the combined image indicated by the data transmitted from the combining unit 112 to be displayed on a display screen. For example, each time combining unit 112 generates a combined image (every time data indicating a combined image is transmitted), the display control unit 114 causes the generated combined image to be displayed on a display screen. In this case, an example of the display screen on which the combined image is displayed by the display control unit 114 may include a display screen of a display unit (not shown) provided in the image processing apparatus 100, and a display screen of an external device connected via a network (or directly) on a wired or wireless connection.

The combined image transmitted from the combining unit 112 (combined image generated in the combining unit 112) is recorded by the recording processing unit 116 at a predetermined timing.

In this example, an example of the recording medium on which the combined image is recorded by the recording processing unit 116 may include a storage unit (not shown), a removable external recording medium connected to the image processing apparatus 100, and a recording medium provided in an external device connected via a network (or directly) on a wired or wireless connection. When the combined image is recorded on a recording medium provided in an external device, the recording processing unit 116 causes the combined image to be recorded on the recording medium provided in the external device, for example, by transmitting data indicating the combined image and a recording instruction for recording the combined image to the external device.

Moreover, an example of the timing at which the combined image is recorded by the recording processing unit 116 may include a timing at which a final combined image is obtained, and a timing before a final combined image is obtained, that is, a predetermined timing at an intermediate stage of the process (combined image generation process) of the above item (3). For example, an example of the predetermined timing at an intermediate stage of the process (combined image generation process) of the above item (3) may include a timing set according to an expected time at which a final combined image is obtained, which described above, and a timing set according to the status of progress in the process (or percentage of completion of a combined image).

The controller 104 includes, for example, the extraction unit 110, the combining unit 112, the display control unit 114, and the recording processing unit 116, and thus plays a leading role in performing the process according to the image processing method of the present embodiment.

Furthermore, the configuration of the controller according to the present embodiment is not limited to the above example. For example, the controller according to the present embodiment may not include the display control unit 114 and/or the recording processing unit 116. The controller according to the present embodiment can play a leading role in performing the process (first still portion extraction process) of the above item (1) to the process (combined image generation process) of the above item (3), without at least one of the display control unit 114 or the recording processing unit 116.

The image processing apparatus 100 performs the process according to the image processing method of the present embodiment (e.g., the process (first still portion extraction process) of the above item (1) to the process (combined image generation process) of the above item (3)), for example, by the configuration shown in FIG. 26. Thus, the image processing apparatus 100 can obtain an image from which a moving object is removed based on a plurality of still images, for example, by the configuration shown in FIG. 26.

Furthermore, the configuration of the image processing apparatus according to the present embodiment is not limited to the configuration shown in FIG. 26. For example, the image processing apparatus according to the present embodiment can include one or more of the extraction unit 110, the combining unit 112, the display control unit 114, and the recording processing unit 116 shown in FIG. 26, as a separate component (e.g., each of these components is implemented as a separate processing circuit). In addition, the image processing apparatus according to the present embodiment may be configured without the display control unit 114 and/or the recording processing unit 116 shown in FIG. 26, as described above. Further, the image processing apparatus according to the present embodiment may include the first still portion extraction unit 118 and the second still portion extraction unit 120 shown in FIG. 26 as a separate component (e.g., each of these components is implemented as a separate processing circuit).

Moreover, the image processing apparatus according to the present embodiment may be configured without an image pickup device (not shown). The image processing apparatus according to the present embodiment, when it includes an image pickup device (not shown), can perform the process according to the image processing method of the present embodiment based on the captured image generated by performing the image capturing in the image pickup device (not shown).

Furthermore, the image processing apparatus according to the present embodiment, when it is configured to perform the process on a stand-alone basis, may not include the communication unit 102.

As described above, the image processing apparatus according to the present embodiment performs, for example, the process (first still portion extraction process) of the above item (1) to the process (combined image generation process) of the above item (3) as the process according to the image processing method of the present embodiment. In this example, the image processing apparatus according to the present embodiment combines the first still portion extracted in the process (first still portion extraction process) of the above item (1) and the second still portion extracted in the process (second still portion extraction process) of the above item (2). In this case, the image processing apparatus according to the present embodiment extracts a still portion based on a motion vector, in comparison with obtaining a combined image by using a simple arithmetic mean in the related art. This motion vector is calculated based on a plurality of still images in each of the process (first still portion extraction process) of the above item (1) and process (second still portion extraction process) of the above item (2). Thus, as the example shown in FIG. 7, when there is no problem that may occur when using the related art, the image processing apparatus according to the present embodiment can obtain an image from which a moving object is removed. In addition, as the example shown in FIG. 8, even when there is a problem that may occur when using the related art, the image processing apparatus according to the present embodiment can obtain an image from which a moving object is removed.

Therefore, the image processing apparatus according to the present embodiment can obtain an image from which a moving object is removed based on a plurality of still images.

Further, an example of the still image processed by the image processing apparatus according to the present embodiment may include one or more of an image captured by an image pickup device (image processing apparatus itself, or an external device), a still image stored in a recording medium, and a frame image partially constituting a moving image stored in a recording medium. The still image stored in a recording medium contains a combined image according to the present embodiment. Thus, even when a combined image that contains the unnecessary subject A1 as shown in A of FIG. 12 is obtained, the image processing apparatus according to the present embodiment can perform the process according to the image processing method of present embodiment based on the combined image and another still image, by processing a plurality of still images. Therefore, the image processing apparatus according to the present embodiment includes, for example, the combined image according to the present embodiment. Thus, even when a combined image that contains the unnecessary subject A1 as shown in A of FIG. 12 is obtained, it is possible to obtain a desired combined image, for example, as shown in B of FIG. 12, by processing a plurality of still images.

As described above, although the present embodiment has been described with reference to an exemplary image processing apparatus, the present embodiment is not limited to the illustrative embodiments set forth herein. The present embodiment is applicable to, for example, various kinds of equipments capable of processing an image. An example of these equipments includes a communication device such as mobile phone or smart phone, a video/music player (or video/music recording and reproducing apparatus), a game machine, a computer such as PC (Personal Computer) or server, a display device such as television receiver, and an image pickup device such as a digital camera. In addition, the present embodiment is applicable to, for example, a processing IC (Integrated Circuit) capable of being incorporated into the equipment as described above.

Further, the process according to the image processing method of the present embodiment may be realized, for example, by an image processing system including a plurality of devices based on the connection to a network (or communication between devices), such as cloud computing.

(Program According to Present Embodiment)

It is possible to obtain an image from which a moving object is removed based on a plurality of still images, by executing a program for causing a computer to function as the image processing apparatus according to the present embodiment in the computer. An example of the program may include a program capable of executing the process of the image processing apparatus according to the present embodiment, such as the process (first still portion extraction process) of the above item (1) to the process (combined image generation process) of the above item (3).

It should be understood by those skilled in the art that various modifications, combinations, sub-combinations and alterations may occur depending on design requirements and other factors insofar as they are within the scope of the appended claims or the equivalents thereof.

For example, in the above description, an illustration has been made of a program for causing a computer to function as the image processing apparatus according to the present embodiment being provided, embodiments of the present disclosure may further provide a storage medium in which the above-described program has been stored therewith.

The above-described configurations are an illustration of an example of an embodiment of the present disclosure, and belong to the technical scope of the present disclosure, as a matter of course.

Additionally, the present technology may also be configured as below.

(1) An image processing apparatus including:

an extraction unit for extracting a first still portion in an image based on a plurality of still images, and for extracting at least a part of a second still portion corresponding to a portion that is not extracted as the first still portion in an image based on the plurality of still images; and

a combining unit for combining the first still portion and the second still portion to generate a combined image.

(2) The image processing apparatus according to (1), wherein the extraction unit extracts a still portion that contains a subject to be extracted as the first still portion.
(3) The image processing apparatus according to any one of (1) to (5), further including:

a display control unit for causing the combined image to be displayed on a display screen.

(4) The image processing apparatus according to (3), wherein the extraction unit extracts a new second still portion each time a number of the still images to be processed increases,

wherein the combining unit, each time the second still portion is newly extracted, combines the first still portion or a previously generated combined image with the newly extracted second still portion to generate a new combined image, and

wherein the display control unit, each time the combined image is generated, causes the generated combined image to be displayed on a display screen.

(5) The image processing apparatus according to (4), further including:

a recording processing unit for recording the combined image generated in the combining unit at a predetermined timing.

(6) The image processing apparatus according to (3), wherein the extraction unit extracts, based on a reduced image obtained by reducing a size of a still image to be processed, the first still portion corresponding to the reduced image, and extracts, based on a reduced image obtained by reducing a size of a still image, a new second still portion corresponding to the reduced image each time a number of the still images to be processed increases, the new second still portion corresponding to the reduced image,

wherein the combining unit, each time the second still portion corresponding to the reduced image is newly extracted, combines the first still portion corresponding to the reduced image or a previously generated combined image corresponding to the reduced image with the newly extracted second still portion corresponding to the reduced image to generate a new combined image corresponding to the reduced image, and

wherein the display control unit, each time the new combined image corresponding to the reduced image is generated, causes the generated combined image to be displayed on a display screen.

(7) The image processing apparatus according to (4) or (6), wherein the display control unit applies a color to a portion that is not included in either of the first still portion or the second still portion in the combined image, and causes a combined image to which the color is applied to be displayed.
(8) The image processing apparatus according to (1) or (2), wherein the extraction unit extracts a still portion based on motion vectors of a plurality of still images.
(9) The image processing apparatus according to any one of (1) to (8), wherein the extraction unit corrects one or more deviations of a vertical direction, a horizontal direction, and a rotation direction in a still image to be processed, and extracts at least one of the first still portion or the second still portion.
(10) The image processing apparatus according to any one of (1) to (9), wherein the still image to be processed by the extraction unit is one or more of images captured by an image pickup device, a still image stored in a recording medium, and a frame image partially constituting a moving image stored in a recording medium.
(11) The image processing apparatus according to any one of (1) to (10), wherein the extraction unit, when a plurality of still images to be processed include a plurality of still images having the extracted first still portion, regards an image indicated by a signal obtained by averaging a signal that corresponds to an region corresponding to the first still portion in the plurality of still images as the first still portion.
(12) The image processing apparatus according to any one of (1) to (11), wherein the extraction unit, when the extraction of the first still portion is completed, notifies a user that the extraction of the first still portion is completed.
(13) The image processing apparatus according to any one of (1) to (12), further including:

an image pickup unit for capturing an image,

wherein the still image to be processed by the extraction unit includes an image captured by the image pickup unit.

(14) An image processing method including:

extracting a first still portion in an image based on a plurality of still images;

extracting at least a part of a second still portion corresponding to a portion that is not extracted as the first still portion in an image based on the plurality of still images; and

combining the first still portion and the second still portion to generate a combined image.

(15) The image processing method according to (14), wherein the step of extracting the first still portion includes extracting a still portion that contains a subject to be extracted as the first still portion.
(16) The image processing method according to (14) or (15), wherein the step of extracting the first still portion and the step of extracting the second still portion include calculating a motion vector based on a plurality of still images and extracting a still portion based on the calculated motion vector.
(17) The image processing method according to any one of (14) to (16), further including:

causing the combined image to be displayed on a display screen.

(18) The image processing method according to any one of (14) to (17), wherein the step of extracting the first still portion includes, when the extraction of the first still portion is completed, notifying a user that the extraction of the first still portion is completed.
(19) The image processing method according to any one of (14) to (18), further including:

capturing an image,

wherein a still image to be processed in the step of extracting the first still portion and the step of extracting the second still portion includes an image captured in the capturing step.

(20) A program for causing a computer to execute:

extracting a first still portion in an image based on a plurality of still images;

extracting at least a part of a second still portion corresponding to a portion that is not extracted as the first still portion in an image based on the plurality of still images; and

combining the first still portion and the second still portion to generate a combined image.

The present disclosure contains subject matter related to that disclosed in Japanese Priority Patent Application JP 2012-021894 filed in the Japan Patent Office on Feb. 3, 2012, the entire content of which is hereby incorporated by reference.

What is claimed is:

1. An image processing apparatus comprising:
an extraction unit for extracting a first still portion in an image based on a plurality of still images, and for extracting at least a part of a second still portion corresponding to a portion that is not extracted as the first still portion in an image based on the plurality of still images; and
a combining unit for combining the first still portion and the second still portion to generate a combined image.

2. The image processing apparatus according to claim 1, wherein the extraction unit extracts a still portion that contains a subject to be extracted as the first still portion.

3. The image processing apparatus according to claim 2, further comprising:
a display control unit for causing the combined image to be displayed on a display screen.

4. The image processing apparatus according to claim 3, wherein the extraction unit extracts a new second still portion each time a number of the still images to be processed increases,
wherein the combining unit, each time the second still portion is newly extracted, combines the first still portion or a previously generated combined image with the newly extracted second still portion to generate a new combined image, and
wherein the display control unit, each time the combined image is generated, causes the generated combined image to be displayed on a display screen.

5. The image processing apparatus according to claim 4, further comprising:
a recording processing unit for recording the combined image generated in the combining unit at a predetermined timing.

6. The image processing apparatus according to claim 3, wherein the extraction unit extracts, based on a reduced image obtained by reducing a size of a still image to be processed, the first still portion corresponding to the reduced image, and extracts, based on the reduced image obtained by reducing the size of the still image to be processed, a new second still portion corresponding to the reduced image each time a number of the still images to be processed increases,
wherein the combining unit, each time the second still portion corresponding to the reduced image is newly extracted, combines the first still portion corresponding to the reduced image or a previously generated combined image corresponding to the reduced image with the newly extracted second still portion corresponding to the reduced image to generate a new combined image corresponding to the reduced image, and
wherein the display control unit, each time the new combined image corresponding to the reduced image is generated, causes the generated combined image to be displayed on a display screen.

7. The image processing apparatus according to claim 4, wherein the display control unit applies a color to a portion that is not included in either of the first still portion or the second still portion in the combined image, and causes a combined image to which the color is applied to be displayed.

8. The image processing apparatus according to claim 2, wherein the extraction unit extracts a still portion based on motion vectors of a plurality of still images.

9. The image processing apparatus according to claim 1, wherein the extraction unit corrects one or more of a vertical direction, a horizontal direction, and a rotation direction deviation in a still image to be processed, and extracts at least one of the first still portion or the second still portion.

10. The image processing apparatus according to claim 1, wherein the still image to be processed by the extraction unit is one or more of an image captured by an image pickup device, a still image stored in a recording medium, and a frame image partially constituting a moving image stored in a recording medium.

11. The image processing apparatus according to claim 1, wherein the extraction unit, when a plurality of still images to be processed include a plurality of still images having the extracted first still portion, regards an image indicated by a signal obtained by averaging signals that correspond to a region corresponding to the first still portion in the plurality of still images as the first still portion.

12. The image processing apparatus according to claim 1, wherein the extraction unit, when the extraction of the first still portion is completed, notifies a user that the extraction of the first still portion is completed.

13. The image processing apparatus according to claim 1, further comprising:
an image pickup unit for capturing an image,
wherein the still image to be processed by the extraction unit includes an image captured by the image pickup unit.

14. An image processing method comprising:
extracting a first still portion in an image based on a plurality of still images;
extracting at least a part of a second still portion corresponding to a portion that is not extracted as the first still portion in an image based on the plurality of still images; and
combining the first still portion and the second still portion to generate a combined image.

15. The image processing method according to claim 14, wherein the step of extracting the first still portion includes extracting a still portion that contains a subject to be extracted as the first still portion.

16. The image processing method according to claim 14, wherein the step of extracting the first still portion and the step of extracting the second still portion include calculating a motion vector based on a plurality of still images and extracting a still portion based on the calculated motion vector.

17. The image processing method according to claim 14, further comprising:
causing the combined image to be displayed on a display screen.

18. The image processing method according to claim 14, wherein the step of extracting the first still portion includes, when the extraction of the first still portion is completed, notifying a user that the extraction of the first still portion is completed.

19. The image processing method according to claim 14, further comprising:
capturing an image,
wherein a still image to be processed in the step of extracting the first still portion and the step of extracting the second still portion includes an image captured in the capturing step.

20. A program for causing a computer to execute:
extracting a first still portion in an image based on a plurality of still images;
extracting at least a part of a second still portion corresponding to a portion that is not extracted as the first still portion in an image based on the plurality of still images; and
combining the first still portion and the second still portion to generate a combined image.
